(19) United States
(12) Patent Application Publication
(10) Pub. No.: US 2025/0190591 A1
(43) Pub. Date: Jun. 12, 2025

(54) STORING AND PROVIDING ACCESS TO ROUND KEYS OF ADVANCED ENCRYPTION STANDARD USING DUAL PORT MEMORY DEVICES

(71) Applicant: Microchip Technology Incorporated, Chandler, AZ (US)

(72) Inventor: Ge GUO, Richmond (CA)

(21) Appl. No.: 18/967,642

(22) Filed: Dec. 3, 2024

Related U.S. Application Data
(60) Provisional application No. 63/609,333, filed on Dec. 12, 2023.

(51) Int. Cl. G06F 21/60; G06F 21/79

(52) U.S. Cl. CPC G06F 21/602; G06F 21/79

(57) ABSTRACT

A system includes one or more processing units adapted to generate, using a first encryption key, a first set of round keys for rounds of an advanced encryption standard (AES) algorithm; generate, using a second encryption key, a second set of round keys; and determine different addresses, of a plurality of memory devices, for the first and second sets of round keys; and store the first and second sets of round keys in the different addresses, wherein the first round key is stored in a memory device, of the plurality of memory devices, using a first port of the memory device, and wherein the memory device is a dual port memory device that includes the first port and a second port.

### RELATED APPLICATION

This application claims priority to U.S. Provisional Patent Application No. 63/609,333 entitled “STORING AND PROVIDING ACCESS TO ROUND KEYS OF ADVANCED ENCRYPTION STANDARD USING DUAL PORT MEMORY DEVICES,” filed Dec. 12, 2024, which is incorporated herein by reference in its entirety.

### FIELD

The present disclosure generally relates to round keys of an advanced encryption standard (AES) algorithm and, for example, to storing and providing access to round keys using dual port memory devices.

### BACKGROUND

AES algorithm is an encryption algorithm that uses the same key to encrypt and decrypt data that is to be protected. With AES algorithm, the data is encrypted over multiple rounds of encryption. For example, the first round key is used to encrypt the data during a first round of encryption, a second round key is used to encrypt the data during a second round of encryption, and so on. An AES-galois/counter mode (GCM) is a mode of operation for the AES algorithm. AES-GCM may be used to implement secure communication, such as secure internet traffic using protocols like transport layer security (TLS).

### SUMMARY

In some implementations, a method comprising generating, using a first encryption key, a first set of round keys for rounds of an AES algorithm; generating, using a second encryption key, a second set of round keys for the rounds of AES algorithm; determining different addresses, of a plurality of memory devices, for the first set of round keys and for the second set of round keys, wherein first addresses of a first round key, of the first set of round keys, are determined based on: a round of AES algorithm associated with the first round key, the first encryption key, and first indexes of words included in the first round of key, and wherein second addresses of a second round key, of the second set of round keys, are determined based on a round of AES algorithm associated with the second round key, the second encryption key, and second indexes of words included in the second round of key; storing the first set of round keys and the second set of round keys in the different addresses, wherein the first round key is stored in a memory device, of the plurality of memory devices, using a first port of the memory device, and wherein the memory device is a dual port memory device that includes the first port and a second port; and retrieving the first set of round keys and the second set of round keys from the different addresses, wherein the first round key is retrieved from the first memory device using the second port of the memory device.

In some implementations, a system comprising: one or more processing units adapted to: generate, using a first encryption key, a first set of round keys for rounds of an AES algorithm; generate, using a second encryption key, a second set of round keys for the rounds of AES algorithm; determine different addresses, of a plurality of memory devices, for the first set of round keys and for the second set of round keys, wherein first addresses of a first round key, of the first set of round keys, are determined based on: a round of AES algorithm associated with the first round key, the first encryption key, and first indexes of words included in the first round of key, and wherein second addresses of a second round key, of the second set of round keys, are determined based on a round of AES algorithm associated with the second round key, the second encryption key, and second indexes of words included in the second round of key; and store the first set of round keys and the second set of round keys in the different addresses, wherein the first round key is stored in a memory device, of the plurality of memory devices, using a first port of the memory device, and wherein the memory device is a dual port memory device that includes the first port and a second port.

In some implementations, a computer program product comprising: one or more computer readable storage media, and program instructions collectively stored on the one or more computer readable storage media, the program instructions comprising: program instructions to generate, using a first encryption key, a first set of round keys for rounds of an AES algorithm; program instructions to generate, using a second encryption key, a second set of round keys for the rounds of AES algorithm; program instructions to determine different addresses, of a plurality of memory devices, for the first set of round keys and for the second set of round keys, wherein first addresses of a first round key, of the first set of round keys, are determined based on: a round of AES algorithm associated with the first round key, the first encryption key, and first indexes of words included in the first round of key, and wherein second addresses of a second round key, of the second set of round keys, are determined based on a round of AES algorithm associated with the second round key, the second encryption key, and second indexes of words included in the second round of key; and program instructions to store the first set of round keys and the second set of round keys in the different addresses, wherein the first round key is stored in a memory device, of the plurality of memory devices, using a first port of the memory device, and wherein the memory device is a dual port memory device that includes the first port and a second port.

### BRIEF DESCRIPTION OF THE DRAWINGS

FIG. 1 is a block schematic diagram of an example system in which an advanced encryption standard (AES) operation may be implemented, in accordance with the present disclosure.

FIG. 2 is a block diagram of an example device, in accordance with the present disclosure.

FIG. 3A is a block schematic diagram of an example of an AES key expansion operation, in accordance with the present disclosure.

FIG. 3B is a block schematic diagram of an example of an environment in which an AES-galois/counter mode (GCM) operation is implemented in association with multiple integrity and data encryption (IDE) sub-streams and multiple AES-GCM instances, in accordance with the present disclosure.

FIG. 3C is a block schematic diagram of an example of a hardware implementation in which an AES-GCM operation is implemented in association with multiple IDE sub-streams and multiple AES-GCM instances, in accordance with the present disclosure.

FIG. 4 is a block schematic diagram showing an example system in which an AES-GCM operation is implemented in association with multiple IDE sub-streams and a single AES-GCM instance, in accordance with the present disclosure.

FIG. 5 is a block schematic diagram of an example of an AES key expansion operation using DP SRAM instances, in accordance with the present disclosure.

FIGS. 6A and 6B are block schematic diagrams showing example key schedule arrays associated with an AES-GCM key expansion operation associated with multiple IDE sub-streams, in accordance with the present disclosure.

FIG. 7 is a block schematic diagram showing an example memory structure for a hardware implementation in which an AES-GCM operation is implemented in association with multiple IDE sub-streams and a single AES-GCM instance, in accordance with the present disclosure.

FIG. 8 is a flow diagram of an example method of storing and providing access to round keys using dual port memory devices, in accordance with the present disclosure.

### DETAILED DESCRIPTION

The following detailed description of example implementations refers to the accompanying drawings. The same reference numbers in different drawings may identify the same or similar elements.

Peripheral component interconnect express (PCIe)-Integrity and Data Encryption (IDE) is a hardware-based encryption mechanism integrated within the PCIe protocol to secure data transmissions between the host system and connected peripheral devices. PCIe is a high-speed interface standard widely used for connecting various components such as storage devices, network cards, and graphics processing units to the motherboard of a computer system. PCIe, as an evolution of the older PCI standard, leverages point-to-point connections and serial links to achieve high data transfer rates, reduced latency, and enhanced scalability. Unlike its predecessor, which utilized a shared parallel bus, PCIe employs a layered architecture that allows for efficient data transmission over multiple lanes, with each lane consisting of two differential signaling pairs: one for transmitting data and the other for receiving data. The number of lanes can vary depending on the device and system requirements, ranging from x1 (one lane) to x16 (sixteen lanes), with higher lane counts providing greater bandwidth.

At the heart of PCIe's communication model are transaction layer packets (TLPs), which are the fundamental units of data transfer between devices. TLPs encapsulate various types of transactions, including memory read and write requests, input/output (I/O) operations, and message signaling. The transaction layer is responsible for generating, transmitting, and receiving these packets, ensuring that data reaches its intended destination accurately and efficiently. TLPs are structured with headers that specify the type of transaction, address information, and other relevant control data, followed by the payload, which contains the actual data being transmitted, and an optional end-to-end cyclic redundancy check (ECRC) to ensure data integrity.

Integral to the operation of the PCIe protocol is the Data Link Layer, which manages the reliable transmission of TLPs between two directly connected PCIe devices. This layer is responsible for flow control (FC), error detection, and error correction. FC in PCIe is implemented through a credit-based system that ensures a sender does not overwhelm the receiver with more data than it can handle. There are three primary types of FC in PCIe: posted, non-posted, and completion FC. Posted transactions, such as memory writes, do not require acknowledgment from the receiver, while non-posted transactions, such as memory reads, require a response from the receiver. Completion FC manages the acknowledgment and potential retry of these non-posted transactions. The FC mechanism relies on the exchange of credit tokens, which indicate the amount of available buffer space on the receiver side.

In addition to FC, the PCIe protocol supports TLP re-ordering to optimize data transfer efficiency. Since PCIe allows for out-of-order delivery of TLPs, the protocol includes mechanisms to reassemble packets in the correct order at the receiver end. This re-ordering capability is particularly important in systems where multiple streams of data are transmitted simultaneously across various lanes. The re-ordering process ensures that transactions are completed in a manner consistent with the original order, preventing data corruption and maintaining the integrity of the data being processed.

A key feature of PCIe is its ability to support multiple streams and sub-streams within a single logical connection, often referred to as an IDE stream. IDE streams enable the transmission of data that requires guaranteed bandwidth and low latency, such as audio or video streams, alongside regular data traffic. Sub-streams within an IDE stream allow for the differentiation and prioritization of data types, ensuring that time-sensitive information is delivered promptly while less critical data may be delayed without affecting overall system performance. This hierarchical structure of streams and sub-streams provides PCIe with the flexibility to manage a wide range of data types and transmission requirements effectively.

Furthermore, PCIe's data link layer includes additional mechanisms for error detection and correction, which are essential for maintaining data integrity during transmission. These mechanisms include the use of a 32-bit cyclic redundancy check (CRC) to detect errors in TLPs and the automatic retransmission of corrupted packets. When an error is detected, the data link layer initiates a retry process, where the erroneous packet is retransmitted to ensure that the correct data is delivered. This error-handling capability, combined with FC and TLP re-ordering, enables PCIe to provide a robust and reliable communication channel between devices, even in the presence of transient errors or variations in data transmission conditions.

Overall, the PCIe protocol's combination of high-speed serial communication, efficient flow control, robust error detection and correction, and support for multiple data streams makes it a versatile and powerful standard for connecting peripheral devices to a computer's CPU. Its layered architecture and advanced features enable it to meet the demands of modern computing environments, where high data transfer rates, low latency, and reliable communication are critical. The protocol's flexibility and scalability also ensure its continued relevance as new technologies and applications emerge, making it a cornerstone of contemporary computer architecture.

The integration of in-line data encryption within the PCIe architecture addresses the growing need for enhanced data security, particularly in environments where sensitive information is frequently transferred across the PCIe bus. By embedding encryption capabilities directly into the PCIe communication path, PCIe-IDE provides real-time encryption and decryption of data, thereby mitigating risks associated with data interception, tampering, and unauthorized access.

The PCIe-IDE framework operates by seamlessly encrypting data packets as they traverse the PCIe bus, without imposing significant latency or requiring substantial modifications to existing hardware and software infrastructures. This is achieved by implementing encryption engines directly within the PCIe controller or the connected devices themselves, allowing for the encryption process to occur in-line with data transmission. The in-line nature of PCIe-IDE ensures that encryption occurs transparently, with minimal impact on system performance. This approach is particularly advantageous in scenarios where high-throughput and low-latency communication are critical, such as in data centers, enterprise storage systems, and secure computing environments. Moreover, PCIe-IDE supports various encryption standards, enabling flexibility in the choice of cryptographic algorithms, which can be tailored to meet specific security requirements and regulatory compliance standards.

Advanced Encryption Standard (AES)-Galois/Counter Mode (GCM) (AES-GCM) is implemented within PCIe-IDE as the cryptographic algorithm responsible for encrypting and authenticating data. AES-GCM is a block cipher mode that combines encryption and authentication into a single, efficient process. In the context of PCIe-IDE, AES-GCM operates by encrypting data blocks using the AES algorithm, while simultaneously generating a cryptographic tag for each block, which serves as a means of authentication. The GCM mode employs a counter-based approach for encryption, allowing for parallel processing of data blocks, which is particularly advantageous for high-throughput environments such as PCIe. The authentication mechanism in GCM leverages the Galois field multiplication, ensuring that any alteration of the encrypted data can be detected with a high degree of certainty.

The AAES-GCM is a widely used encryption algorithm that provides both confidentiality and authenticity of data. AES-GCM combines the AES block cipher with the Galois/Counter Mode of operation, allowing for efficient and secure encryption of data. In AES-GCM, the encryption process involves multiple rounds, each using a unique round key derived from the initial encryption key. The algorithm first expands the initial key into a series of round keys through a key expansion process. These round keys are then used in successive rounds of the encryption process to transform the plaintext into ciphertext.

The GCM aspect of AES-GCM provides authenticated encryption, meaning it not only encrypts the data but also generates an authentication tag. This tag can be used to verify the integrity and authenticity of the encrypted data. GCM operates by using a counter for encryption and a Galois field multiplication for authentication. This combination allows for parallel processing of the data, making AES-GCM both secure and efficient for high-speed communication channels. AES-GCM is able to process additional authenticated data (AAD), which is data that is not encrypted but is included in the authentication process. This feature may be useful in scenarios where some data needs to remain in plaintext while still being authenticated, such as packet headers in network protocols.

In the context of AES-GCM, an “encryption key” (sometimes referred to as a “key”) refers to a piece of secret information used to control the encryption and decryption processes. The encryption key is a fundamental component of the cryptographic system, serving as the primary input that determines how the plaintext is transformed into ciphertext during encryption and how the ciphertext is transformed back into plaintext during decryption. In AES-GCM, the encryption key may be 128, 192, or 256 bits in length, with longer keys generally providing higher levels of security.

Encryption keys are used in AES-GCM to initialize the encryption process and generate a series of round keys. The initial encryption key is expanded through a key schedule algorithm to produce a set of round keys, which are then used in each round of the encryption process. A “round key” is a derivative of the initial encryption key, generated through the key expansion process. In AES, the number of round keys is equal to the number of rounds plus one, as an initial round key is used before the first round. Each round key is the same size as the block being encrypted (128 bits in AES). Round keys introduce variability into each round of the encryption process, enhancing the security of the algorithm by ensuring that each round uses a different key. This approach helps to resist various cryptanalytic attacks by increasing the complexity of the relationship between the ciphertext and the original key.

During encryption, the round keys are combined with the data state, typically through an XOR operation, to introduce key-dependent transformations. This process ensures that the ciphertext is dependent on both the plaintext and the secret key, making it computationally infeasible to recover the plaintext without knowledge of the key.

However, in systems that require high-speed encryption and decryption of multiple data streams, traditional implementations of AES-GCM often struggle with efficiently managing and accessing the round keys for multiple encryption processes running concurrently. This can lead to bottlenecks in the encryption process, reducing overall system performance, and limiting the ability to handle multiple data streams simultaneously. Furthermore, in systems where multiple keys or multiple instances of AES-GCM are required, the management and storage of round keys become increasingly complex. This complexity can lead to increased hardware requirements, higher power consumption, and potential security vulnerabilities if not managed properly.

Implementations described herein are directed to utilizing dual-port memory devices for storing and providing access to round keys of the AES algorithm. This approach allows for efficient management of round keys for multiple AES-GCM instances or multiple keys within a single instance, improving the overall performance and flexibility of AES-GCM implementations.

For example, in some implementations, a method is provided for generating, storing, and retrieving round keys for multiple AES encryption processes. The method involves generating a first set of round keys using a first encryption key and a second set of round keys using a second encryption key. These round keys are then stored in different addresses of a plurality of memory devices. The addresses for storing the round keys are determined based on the round of the AES algorithm associated with each round key, the encryption key used to generate the round key, and the indexes of words included in the round key.

The implementation utilizes dual-port memory devices, such as dual-port static random-access memory (DP SRAM) or dual-port register files (DP RF). These memory devices have two independent access ports, allowing for simultaneous read and write operations. By using AES-GCM using dual-port memory devices, some implementations may facilitate the concurrent writing of new round keys and reading of existing round keys during encryption operations.

The round keys may be organized in the memory devices in a structured manner. For example, round keys generated for a specific round of the AES algorithm may be stored on a particular memory device of the plurality of memory devices. This organization allows for efficient access to the required round keys during the encryption process. The first port of the dual-port memory device may be used for writing the round keys, while the second port may be used for reading the round keys during the encryption process.

Some implementations include a method for retrieving the stored round keys. When a request to perform an AES algorithm on data is received, the system determines the round for the AES algorithm, the key for the round, and the index for the word of the round key needed. It then obtains the required word from the memory device via the second port and uses it to perform the AES algorithm on the data to obtain encrypted data.

To further enhance efficiency, the solution may employ a key schedule array structure. This structure allows for the storage and retrieval of multiple round keys for different key indexes, facilitating the implementation of the AES algorithm with multiple key candidates. The key schedule array may be organized into rows corresponding to the rounds of the AES-256 algorithm, with each row containing the words for a specific round key.

The present disclosure may provide several benefits in the implementation of AES-GCM. By using dual-port memory devices, the solution allows for simultaneous writing of new key schedules and reading of existing round keys, potentially improving the overall speed of encryption operations. The structured storage of round keys may enable more efficient access to the required keys during the encryption process, reducing latency, and improving throughput.

Furthermore, the ability to manage multiple sets of round keys efficiently may allow for the implementation of AES-GCM with multiple key candidates or multiple instances using a single physical AES-GCM instance. This can lead to reduced hardware requirements and improved resource utilization in systems requiring multiple encryption streams or keys. The proposed solution may also enhance the flexibility of AES-GCM implementations, allowing for easier scaling and adaptation to different encryption scenarios.

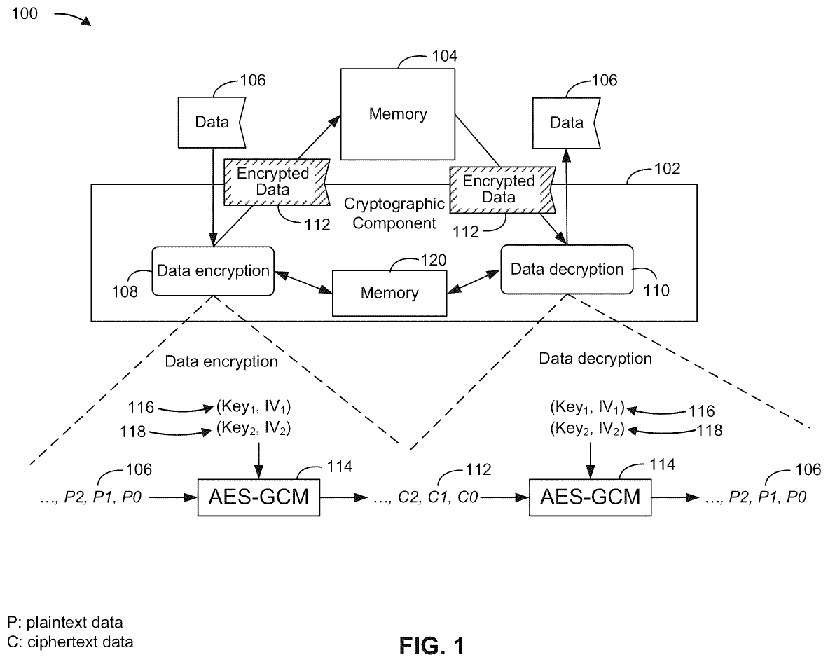

FIG. 1 illustrates a block schematic diagram of an example environment 100 in which an AES operation may be implemented, in accordance with the present disclosure. The environment 100 includes a cryptographic component 102, a memory 104, and data 106. The cryptographic component 102 may be a hardware or software module configured to perform encryption and decryption operations. As used herein, the term “component” may refer to a unit implemented in hardware, software, firmware, or a combination thereof, capable of performing one or more specific functions. For example, the cryptographic component 102 may be implemented as an application-specific integrated circuit (ASIC), a field-programmable gate array (FPGA), or a software module designed specifically for cryptographic operations.

As is further shown in FIG. 1, the cryptographic component 102 may include an AES-GCM component 114 configured to perform the encryption process 108 and the decryption process 110. The AES-GCM component 114 may include one or more AES-GCM instances. In some implementations, as shown in FIG. 1, the data 106 may be provided to the cryptographic component 102, which uses the AES-GCM component 114 to perform the data encryption process 108 to generate encrypted data 112 for storage in the memory 104. To retrieve the data 106 from the memory 104, the data decryption process 110 is performed on the encrypted data 112 to generate the data 106. For example, as shown, the data 106 may be plaintext data (shown as “ . . . , P2, P1, P0”) and the data encryption process 108 may be used for converting the plaintext data into the encrypted data 112, which may be ciphertext data (shown as “ . . . , C2, C1, C0”), while the data decryption process 110 may perform the reverse operation, converting the encrypted data 112 (ciphertext data) back into the data 106 (plaintext data). In some examples, P2, P1, and P0 may represent chunks of a defined size of data. These processes may utilize various encryption algorithms and modes of operation, such as the AES-GCM.

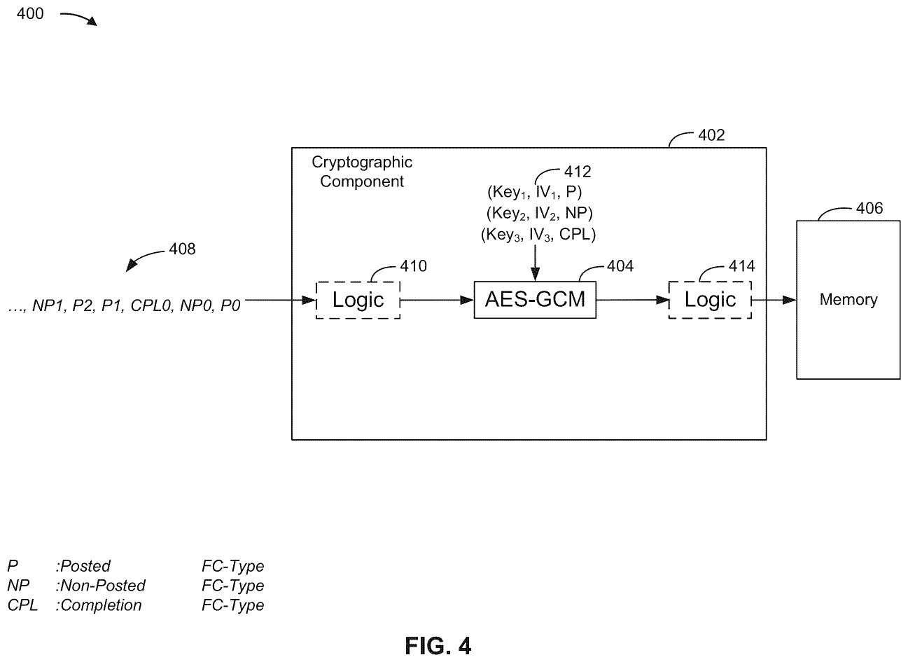

In accordance with various implementations described herein, as described in further detail in connection with FIGS. 4-6B below, the data encryption process 108 may include generating multiple sets of round keys. As shown in FIG. 1, the AES-GCM 114 may receive a first AES input 116, which may include a first encryption key (shown as “Key₁”) and a first initialization vector (IV) (shown as “IV₁”). The AES-GCM 114 may receive a second AES input 118, which may include a second encryption key (shown as “Key₂”) and a second IV (shown as “IV₂”). An initialization vector may refer to an input (e.g., a number) that is used to encrypt data.

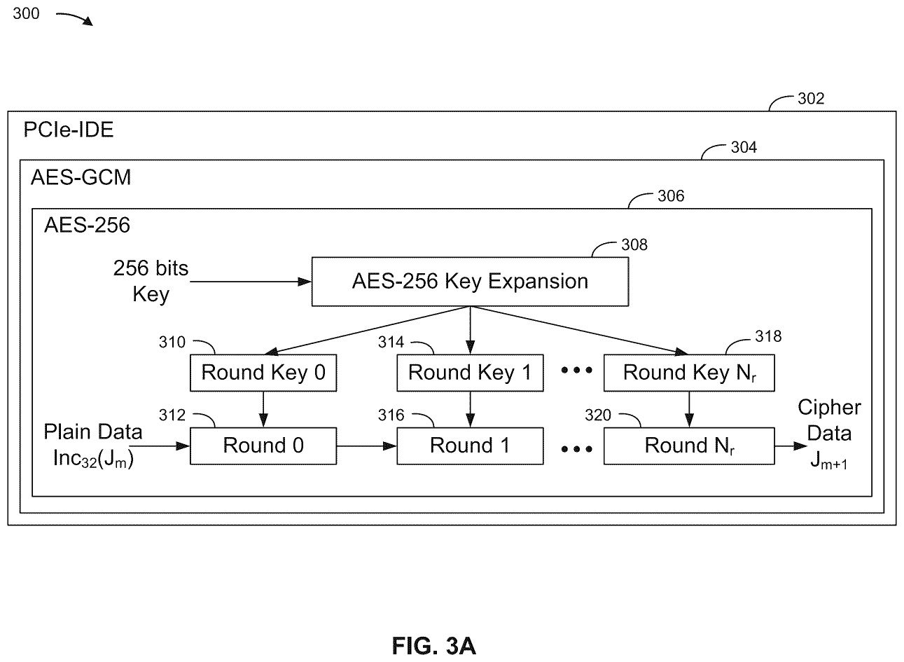

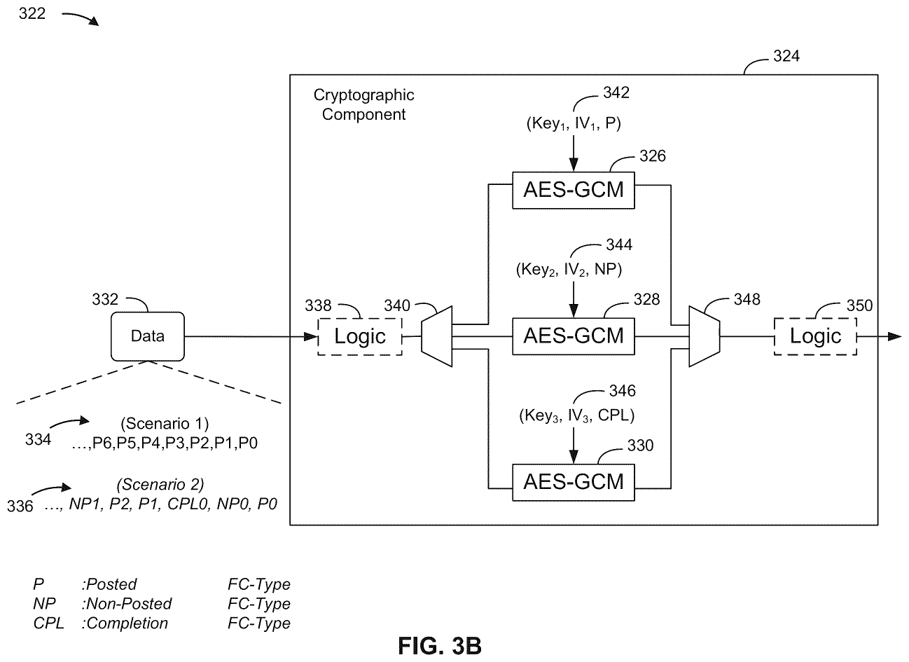

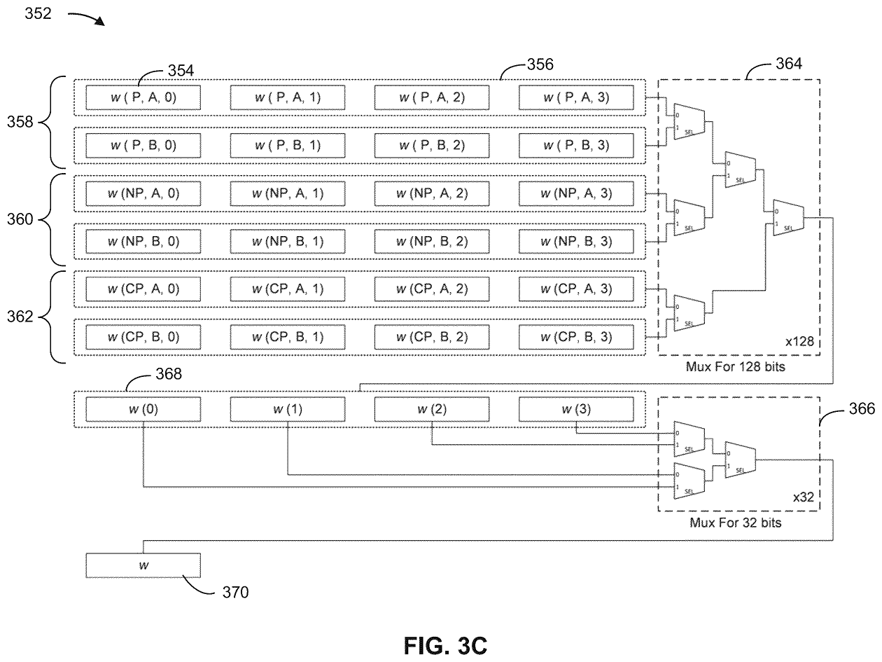

The data encryption process 108 may include generating, using the first encryption key (“Key₁”), a first set of round keys for rounds of an AES algorithm. Similarly, the data encryption process 108 may include generating, using the second encryption key (shown as “Key₂”), a second set of round keys for the rounds of the AES algorithm. In this context, a “round key” refers to a derived key used in a specific round of the AES encryption process. For example, in a 128-bit AES encryption, there may be 10 round keys, each used in a corresponding round of the encryption process. Round keys are derived from the first or second encryption keys using a key expansion operation, explained in further detail below in connection with FIG. 3A.

The first and second encryption keys are secret keys that may be, for example, 128, 192, or 256 bits in length. In some implementations, the first encryption key may be associated with one data stream or encryption context, while the second encryption key may be used for a different data stream or encryption context. In this way, the cryptographic component 102 may handle multiple encryption scenarios simultaneously. For example, the data encryption process 108 within the cryptographic component 102 may use the first encryption key to generate a first set of round keys for encrypting one portion of the input data 106, and use the second encryption key to generate a second set of round keys for encrypting another portion of the input data 106.

The first IV (“IV₁”) and the second IV (“IV₂”) provided in the AES inputs 116 and 118, respectively, may be used to initialize a counter mode of operation in the AES-GCM 114. This ensures that each encryption operation produces unique ciphertext, even when encrypting identical plaintext with the same key. The AES-GCM component 112 may combine the IV with a counter value to create a unique input for each block encryption, enhancing the security of the encryption process. In some implementations, the AES input 116 and/or 118 may also include additional authenticated data (AAD) that is not encrypted but is included in the authentication process. The AES-GCM component 114 may process this AAD along with the encrypted data to generate an authentication tag, which can be used to verify the integrity and authenticity of both the encrypted data and the AAD.

The cryptographic component 102 may include a memory 120. In some implementations, the memory 120 may be, be similar to, include, or be included in the memory 104. The memory 120 may include one or more memory devices for storing the round keys. In some implementations, these memory devices may be dual port memory devices, such as DP SRAM or DP RF. A dual port memory device, as used herein, refers to a memory device that has two independent access ports, allowing for simultaneous read and write operations. This feature enables the cryptographic component 102 to store the first set of round keys and the second set of round keys in different addresses of the plurality of memory devices while simultaneously allowing access to stored round keys for ongoing encryption or decryption processes.

The cryptographic component 102 may determine different addresses for the first set of round keys and for the second set of round keys within the plurality of memory devices. These addresses may be determined based on several factors. For example, the cryptographic component 102 may determine addresses for storing round keys using various strategies based on the round of the AES algorithm, the encryption key used to generate the round keys, and the indexes of the words.

First, the round of the AES algorithm associated with each round key may influence its storage location. For example, all round keys for the first round of encryption across different key sets may be stored in contiguous memory locations. In some implementations, the memory devices may be partitioned such that each partition corresponds to a specific round of the AES algorithm. For example, a first partition may store all round keys for the first round, a second partition for the second round, and so on. This organization may allow for parallel access to round keys from different rounds, potentially improving the overall speed of the encryption process. In some implementations, the address for storing a round key may be calculated using an offset based on the round number. For instance, the base address for storing round keys may be incremented by a fixed amount for each subsequent round. This approach may result in a linear arrangement of round keys in memory, where keys for earlier rounds occupy lower memory addresses and keys for later rounds occupy higher addresses.

Second, the encryption key used to generate the round key (e.g., the first encryption key or the second encryption key) may affect the address determination. The cryptographic component 102 may assign a unique offset to each encryption key. This offset may be added to the base address when determining the storage location for round keys generated from that specific key. For example, round keys generated from the first encryption key may be stored starting at address 0x1000, while round keys from the second encryption key may start at address 0x2000. This approach may allow for efficient separation and organization of round keys from different encryption keys.

In some implementations, the cryptographic component 102 may employ a hash function that takes the encryption key as input and produces a unique value. This hash value may be incorporated into the address calculation formula. For instance, the address may be determined as (hash (key) XOR round_number XOR word_index)+base_address. By using the encryption key in this manner, the cryptographic component 102 may create a pseudo-random distribution of round key addresses, which may enhance security by making it more difficult for an attacker to predict the memory locations of specific round keys.

Third, the indexes of words included in the round key may be considered when determining the storage address. For example, the cryptographic component 102 may use the word index as an offset within a block of memory allocated for a specific round key. For example, if each round key consists of four 32-bit words, the address for each word may be calculated as (base_address+(word_index 4)), where base_address is the starting address for the round key and word_index ranges from 0 to 3. This approach may allow for efficient access to individual words within a round key, which may be useful in implementations that require fine-grained control over the encryption process.

In some implementations, the cryptographic component 102 may implement an interleaved storage pattern based on word indexes. In this approach, words with the same index from different round keys may be stored in adjacent memory locations. For instance, all first words (index 0) from different round keys may be stored consecutively, followed by all second words (index 1), and so on. The address may be calculated as (base_address+(word_index total_round_keys)+round_key_id), where total_round_keys is the number of round keys being stored and round_key_id is a unique identifier for each round key. This organization may improve cache efficiency when accessing specific word positions across multiple round keys, which may be beneficial in parallel processing scenarios.

Some implementations may use a more complex addressing scheme. For example, the memory may be organized into a two-dimensional structure, where one dimension represents the round number and the other represents the key ID or word index. In some implementations, the cryptographic component 102 may use a formula that combines these factors to generate unique addresses. In some cases, the address may be calculated as (round_number key_id word_index)+base_address, where round_number is the current round of the AES algorithm, key_id is a unique identifier for the encryption key used to generate the round keys, and word_index is the position of the word within the round key. This organization may allow for efficient retrieval of all round keys for a specific round across multiple key sets, which may be useful in implementations that process multiple data streams simultaneously.

The addresses determined by the cryptographic component 102 may be used for various purposes within the AES-GCM implementation. In some implementations, the addresses may be used to store round keys in specific memory locations for quick access during encryption operations. For instance, round keys for the first round of encryption may be stored in lower memory addresses, while round keys for later rounds may be stored in higher addresses. This organization may allow the cryptographic component 102 to quickly retrieve the necessary round keys as the encryption process progresses through its rounds. Additionally, the addresses may be used to manage multiple sets of round keys for different encryption streams or scenarios, enabling the system to switch between different keys or encryption contexts efficiently.

In the encryption process, the first round key may be stored in a memory device of the plurality of memory devices using a first port of the memory device. This storage operation may occur simultaneously with the retrieval of other round keys for ongoing encryption processes, thanks to the dual-port nature of the memory devices. The first round key and subsequent round keys may be retrieved from the memory device using the second port of the memory device during the encryption process.

The environment 100 supports multiple encryption streams or keys simultaneously through its flexible and efficient memory management system. This capability allows the cryptographic component 102 to handle various encryption scenarios concurrently, enhancing the overall performance and versatility of the system. By utilizing dual-port memory devices and implementing sophisticated addressing schemes, the environment 100 can efficiently store and retrieve round keys for multiple encryption processes without significant overhead or contention.

In the context of multiple encryption streams, the environment 100 may process different data streams, each potentially using a unique encryption key or requiring a distinct encryption context. For example, one stream may be associated with the first encryption key (“Key₁”) and its corresponding initialization vector (“IV₁”), while another stream may use the second encryption key (“Key₂”) and its initialization vector (“IV₂”). The AES-GCM component 114 may generate separate sets of round keys for each of these streams, storing them in the memory 120 using the addressing schemes described above.

The dual-port nature of the memory devices in the environment 100 plays a role in supporting multiple encryption streams. With two independent access ports, these memory devices allow for simultaneous read and write operations. This feature may enable the cryptographic component 102 to store new round keys for one encryption stream using the first port while retrieving existing round keys for another ongoing encryption process using the second port. This simultaneous access capability may significantly reduce potential bottlenecks that could arise when managing multiple encryption streams, allowing for efficient parallel processing of different data streams.

In some cases, the cryptographic component 102 may receive a request to perform an AES algorithm on data using a word of the first round key. In response, it may determine the round for the AES algorithm, the key for the round, and the index for the word. It can then obtain the required word from the appropriate memory device via the second port and use it to perform the AES algorithm on the data to obtain encrypted data.

In the context of the AES algorithm, a word typically refers to a 32-bit unit of data. The AES algorithm operates on a 4×4 array of bytes, which is often represented as four words. These words form the basic building blocks for the encryption and decryption processes. In the key expansion process of AES, words play a role in generating the round keys. A round key is a key derived from the original encryption key that is used in a specific round of the AES algorithm. The AES algorithm consists of multiple rounds, with each round using a unique round key. The number of rounds depends on the key size: 10 rounds for 128-bit keys, 12 rounds for 192-bit keys, and 14 rounds for 256-bit keys. Each round key is typically the same size as the data being encrypted (128 bits or four words). The round keys are generated through a key expansion process (as described below in connection with FIG. 3A), where the original encryption key is used to derive a series of round keys, one for each round of the algorithm.

A round in the AES algorithm refers to a set of transformations applied to the data being encrypted or decrypted. Each round, except for the final round, typically consists of four main operations: SubBytes (byte substitution), ShiftRows (row permutation), MixColumns (column mixing), and AddRoundKey (key addition). The round keys generated from the key expansion process are used in the AddRoundKey step of each round.

The index for a word in a round key indicates its position within the round key. For example, in a 128-bit round key consisting of four 32-bit words, the word indexes may range from 0 to 3. These indexes may be used in various ways during the encryption process and in the storage and retrieval of round keys. For instance, the word index may be used to calculate memory addresses for storing individual words of a round key or to access specific portions of a round key during the encryption operations.

In the AES algorithm, these elements—words, round keys, rounds, and word indexes—are intricately related and used together to perform the encryption and decryption processes. The original encryption key is expanded into a series of round keys, with each round key consisting of multiple words. During each round of the algorithm, the appropriate round key is used in the AddRoundKey step, where it is combined with the intermediate state of the data being encrypted. The word indexes may be used to efficiently manage the storage and retrieval of these round keys, allowing for quick access to the specific words needed for each round of the encryption process.

Implementations of the environment 100 may provide an efficient method for storing and providing access to round keys of the AES using dual port memory devices. By leveraging the dual-port capabilities of the memory devices and organizing the round keys in a structured manner, the system can support high-speed encryption and decryption of multiple data streams, addressing the challenges faced by traditional AES-GCM implementations in managing round keys for concurrent encryption processes.

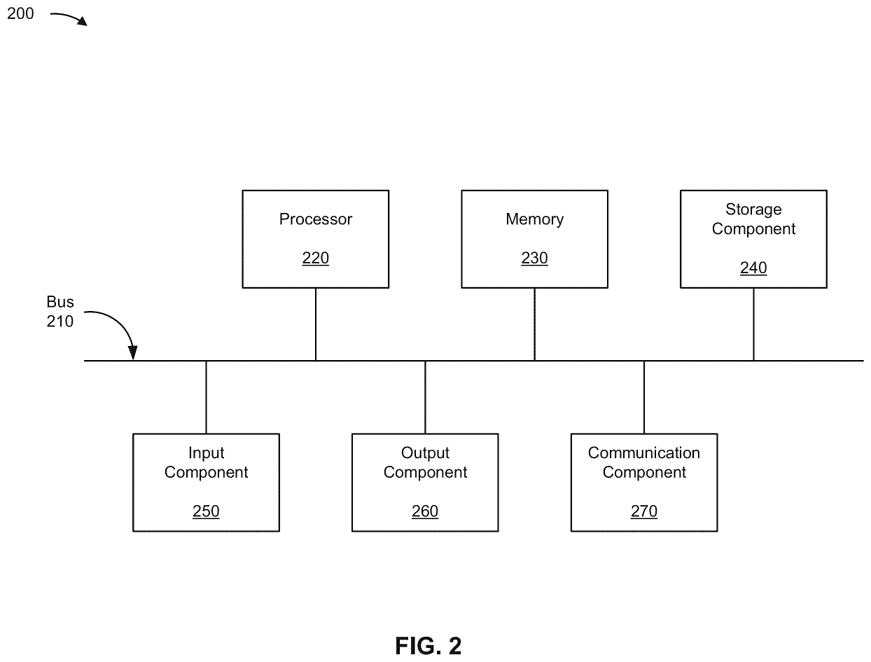

FIG. 2 is a diagram of example components of a device 200, in accordance with the present disclosure. The device 200 may be used to implement one or more aspects of an AES-GCM operation in accordance with the present disclosure. In some implementations, the device 200 may refer to one or more devices 200 and one or more components of device 200. As shown in FIG. 2, device 200 may include a bus 210, a processor 220, a memory 230, a storage component 240, an input component 250, an output component 260, and a communication component 270. Device 200 may be, for example, a computing device.

Bus 210 includes a component that enables wired or wireless communication among the components of device 200. Processor 220 may be a central processing unit, a graphics processing unit, a microprocessor, a controller, a microcontroller, a digital signal processor, an FPGA, an ASIC, or another type of processing component. Processor 220 is implemented in hardware, firmware, or a combination of hardware and software. In some implementations, processor 220 includes one or more processors capable of being programmed to perform a function. Memory 230 includes a random access memory, a read only memory, or another type of memory (e.g., a flash memory, a magnetic memory, or an optical memory).

Storage component 240 stores information or software related to the operation of device 200. For example, storage component 240 may include a hard disk drive, a magnetic disk drive, an optical disk drive, a solid state disk drive, a compact disc, a digital versatile disc, or another type of non-transitory computer-readable medium. Input component 250 enables device 200 to receive input, such as user input or sensed inputs. For example, input component 250 may include a touch screen, a keyboard, a keypad, a mouse, a button, a microphone, a switch, a sensor, a global positioning system component, an accelerometer, a gyroscope, or an actuator. Output component 260 enables device 200 to provide output, such as via a display, a speaker, or one or more light-emitting diodes. Communication component 270 enables device 200 to communicate with other devices, such as via a wired connection or a wireless connection. For example, communication component 270 may include a receiver, a transmitter, a transceiver, a modem, a network interface card, or an antenna.

Device 200 may perform one or more processes described herein. For example, a non-transitory computer-readable medium (e.g., memory 230 or storage component 240) may store a set of instructions (e.g., one or more instructions, code, software code, or program code) for execution by processor 220. Processor 220 may execute the set of instructions to perform one or more processes described herein. In some implementations, execution of the set of instructions, by one or more processors 220, causes the one or more processors 220 or the device 200 to perform one or more processes described herein. In some cases, a number of processors 220 may perform a process in parallel. In some cases, one or more processors may perform one or more aspects of a process while one or more other processors may perform one or more other aspects of the process. Similarly, instructions may be duplicated, distributed, and/or partitioned across two or more memories 230. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 2 are provided as an example. Device 200 may include additional components, fewer components, different components, or differently arranged components than those shown in FIG. 2. For example, the processor 220 may refer to two or more processors and the memory 230 may refer to two or more memories 230. Additionally, or alternatively, a set of components (e.g., one or more components) of device 200 may perform one or more functions described as being performed by another set of components of device 200.

FIG. 3A is a block schematic diagram of an example 300 of an AES key expansion operation, in accordance with the present disclosure. The example 300 illustrates the AES key expansion operation within the context of a PCIe-IDE environment 302 and an AES-GCM environment 304. The AES-256 operation 306 shown in the figure represents a specific implementation of the AES algorithm with a 256-bit key length. This implementation is commonly used in various secure communication protocols and data protection schemes.

The AES algorithm, as depicted in FIG. 3A, employs a key expansion process to derive a series of round keys from an initial encryption key. This process is used for the security and effectiveness of the encryption algorithm. In the AES-256 variant, the key expansion starts with a 256-bit input key, which is then used to generate a set of round keys for each round of the encryption process.

The key expansion component 308 in FIG. 3A is responsible for generating these round keys. It takes the initial 256-bit encryption key as input and produces a series of round keys, including round key 0 310, round key 1 314, and subsequent round keys up to round key Nr 318, where Nr represents the final round number. For AES-256, there are typically 14 rounds (e.g., r∈{0, 1, 2, . . . , 14}), resulting in 15 round keys (including the initial key). Each round key is 128 bits long, despite the initial key being 256 bits. To clarify, in the context of AES-256, ‘r’ and ‘Nr’ may be used interchangeably to represent the number of rounds. In AES-256, there are typically 14 rounds, so the final round number is often denoted as Nr=14. The round key 318 in FIG. 3A is labeled as “round key Nr” to maintain consistency with the variable notation used for the number of rounds. In some implementations, ‘N’ may be used to represent the total number of round keys, which would be Nr+1 (including the initial round key). For AES-256, N would typically equal 15 (14 rounds plus the initial round key). For example, the key expansion process may generate round keys from 0 to Nr, where round key 0 is used before the first round, round keys 1 to Nr−1 are used in the main rounds, and round key Nr is used in the final round. This notation helps to distinguish between the round number (r) and the total number of round keys (N), while maintaining consistency with the AES algorithm structure.

The initial encryption key used in the AES algorithm may come from various sources, depending on the specific implementation and security requirements of the system. In some cases, the initial encryption key may be stored in a secure memory location within the cryptographic component 102 or in a separate secure key storage module. This secure storage may be implemented using hardware security modules (HSMs) or trusted platform modules (TPMs) that provide tamper-resistant storage for sensitive cryptographic material.

In other implementations, the initial encryption key may be generated dynamically by a cryptographically secure random number generator (CSPRNG) within the device. This approach may enhance security by producing a unique encryption key for each encryption session or operation. The CSPRNG may use various sources of entropy, such as hardware-based random number generators or environmental noise, to ensure the randomness and unpredictability of the generated keys.

Some systems may employ key derivation functions (KDFs) to generate the initial encryption key from a master key or a passphrase. This method may allow for the creation of unique encryption keys for different purposes or sessions while maintaining a single master secret. Key derivation may also involve the use of salts or other contextual information to further enhance security and prevent key reuse across different contexts. In the context of KDFs, salts may be random data used as additional input to the key derivation process. Salts may serve several purposes in enhancing the security of the derived keys. They may help prevent dictionary attacks by making each derived key unique, even if the same master key or passphrase is used multiple times. Salts may also increase the computational cost of attempting to crack the derived keys through brute-force methods. In some implementations, salts may be stored alongside the derived keys or may be generated using a deterministic method based on other contextual information. The use of salts in KDFs may contribute to the overall robustness of the key management system within the AES encryption process.

In networked environments, the initial encryption key may be obtained through a key exchange protocol, such as Diffie-Hellman or Elliptic Curve Diffie-Hellman (ECDH). These protocols allow two parties to securely establish a shared secret over an insecure channel, which can then be used as the initial encryption key for subsequent AES operations. For some applications, the initial encryption key may be provided by an external key management system. This approach may be used in enterprise environments where centralized key management is required for compliance or operational reasons. The key management system may distribute encryption keys to various devices or components as needed, potentially rotating encryption keys on a regular basis to maintain security.

The key expansion process in AES-GCM follows a specific algorithm designed to ensure that each round key is both unique and cryptographically strong. This process involves a combination of operations such as byte substitution, word rotation, and XOR operations with round constants. These operations are carefully designed to introduce non-linearity and prevent simple relationships between the round keys, which could potentially weaken the encryption.

The expanded round keys are then used in the encryption process, as illustrated by the round operations in FIG. 3A. Round 0 operation 312 uses round key 0 310, round 1 operation 316 uses round key 1 314, and so on, until the final round Nr operation 320 which uses round key Nr 318. In each round, the round key is combined with the data state (typically through an XOR operation) to introduce the key material into the encryption process. A “data state” may refer to the intermediate result of the encryption process at any given point during the algorithm's execution. The data state may be represented as a two-dimensional array of bytes, typically organized as a 4×4 matrix for AES-128, AES-192, and AES-256. This matrix may be referred to as the “state array” or simply “state.” As the encryption process progresses through its rounds, the data state may be continuously transformed by various operations such as SubBytes, ShiftRows, MixColumns, and AddRoundKey.

The AES-GCM key expansion and round operations as shown in FIG. 3A are designed to process data in blocks. For example, the AES-GCM algorithm may process data in fixed-size blocks. For AES, a data block may typically be 128 bits (16 bytes) in length, regardless of the key size used (128, 192, or 256 bits). This fixed block size may allow for efficient implementation in both hardware and software. When encrypting data that is larger than the block size, the data may be divided into multiple blocks, each processed separately. For example, in a scenario where a user wants to encrypt a 1024-byte file using AES-256 in GCM mode, the file may be divided into eight 128-byte blocks (1024÷128=8). Each of these blocks may then be processed individually through the AES rounds, with the GCM mode ensuring that the encryption of each block is dependent on the previous blocks, thereby enhancing security. In some implementations, if the last block is smaller than 128 bytes, padding schemes may be employed to bring it up to the full block size before encryption.

The plain data input (labeled as “Plain Data InC32(J-m)”) represents the input data block. This data undergoes multiple rounds of transformation, incorporating the round keys at each step, until it emerges as the encrypted output (labeled as “Cipher Data Jm+1”).

FIG. 3B illustrates an environment 322 that implements an AES-GCM operation with multiple IDE sub-streams and multiple AES-GCM instances. The environment 322 includes a cryptographic component 324 that contains three AES-GCM instances: a first AES-GCM instance 326, a second AES-GCM instance 328, and a third AES-GCM instance 330. Each AES-GCM instance is associated with a respective flow control type (FC-type) and, thus, a respective transaction layer packet (TLP) sub-stream. This configuration allows for parallel processing of different data streams, potentially improving overall encryption performance.

In the context of PCIe communication, an FC-type may refer to a specific category of data transmission within the PCIe protocol. FC-types may be used to manage the flow of data between different components in a PCIe system, ensuring efficient and reliable communication. The PCIe specification may define several FC-types, including Posted (P), Non-Posted (NP), and Completion (CPL), each serving a distinct purpose in the data transfer process.

The relationship between an FC-type and a TLP sub-stream may be closely intertwined. A TLP sub-stream may represent a logical grouping of related data packets within the PCIe communication framework. Each TLP sub-stream may be associated with a specific FC-type, which determines how the data within that sub-stream is handled and prioritized during transmission. For example, a Posted TLP sub-stream may contain write transactions that do not require immediate responses, while a Non-Posted TLP sub-stream may include read requests that necessitate completion packets in return.

In some implementations, the association between FC-types and TLP sub-streams may allow for more granular control over data flow and resource allocation within a PCIe system. By categorizing data into different sub-streams based on their FC-types, the PCIe protocol may enable more efficient management of bandwidth, prioritization of critical transactions, and optimization of overall system performance. This relationship between FC-types and TLP sub-streams may play a role in the design and implementation of PCIe-based systems, including those that incorporate advanced encryption mechanisms like AES-GCM.

The cryptographic component 324 receives data input 332, which may include various types of data to be encrypted. The system can handle different processing scenarios, as indicated by the first scenario input 334 and second scenario input 336. These inputs feed into an input logic 338, which determines how the incoming data should be distributed among the AES-GCM instances 326, 328, and 330. For example, the input logic 338 may determine, for each data unit (e.g., data packet, data block, etc.), the FC-type associated therewith, and may route the data based on the determined FC-type. Thus, incoming data having a Posted (P) FC-type may be routed to the AES-GCM instance 326, incoming data having a Non-Posted (NP) FC-type may be routed to the AES-GCM instance 328, and incoming data having a completion (CPL) FC-type may be routed to the AES-GCM instance 330.

A demultiplexer 340 is used to route the input data to the appropriate AES-GCM instance based on the scenario or data type. Each AES-GCM also has a respective AES input. A first AES input 342 is provided to the AES-GCM instance 326, a second AES input 344 is provided to the AES-GCM 328 instance, and a third AES input 346 is provided to the AES-GCM 330 instance. An AES input may refer to the set of parameters required to initialize and perform an AES operation. An AES input (e.g., AES input 116) typically includes an encryption key, an IV, and in some cases, AAD, as explained above in connection with FIG. 1. In some cases, as shown, the AES input also may include an indication of an FC-type associated with the AES-GCM instances. The AES input may come from various sources depending on the system architecture and security requirements. In some implementations, the encryption key may be generated by a key management module within the cryptographic component, while the IV may be produced by a separate IV generation module. The AAD, if used, may be derived from packet headers or other contextual information related to the data being encrypted. The generation of AES input components may involve multiple steps and can be performed by different parts of the system. For instance, the cryptographic component may request a new key from a hardware security module, generate an IV using a secure random number generator, and combine these with AAD extracted from the input data stream. This process may ensure that each encryption operation uses a unique set of input parameters, enhancing the security of the overall system.

Each AES-GCM instance is associated with a specific key type. The respective AES input 342, 344, and 346 includes the corresponding key, an initialization vector, and an indication of the corresponding FC-type. For example, the AES input 342 includes a tuple that includes a first encryption key (“Key₁”) a first IV (“IV₁”), and a first FC-type indication (“P”). The AES input 344 includes a tuple that includes a second encryption key (“Key₂”), a second IV (“IV₂”), and a second FC-type indication (“NP”). The AES input 346 includes a tuple that includes a third encryption key (“Key₃”), a third IV (“IV₃”), and a third FC-type indication (“CPL”).

After processing by the AES-GCM instances, the encrypted outputs are combined using a multiplexer 348. Each AES-GCM instance may process data by utilizing the provided encryption key, IV, and FC-type in a specific manner. The encryption key may be used to generate a series of round keys through the key expansion process, which are then employed in the various rounds of the AES algorithm. The IV may be used to initialize the counter mode of operation, ensuring that each encryption operation produces unique ciphertext even when encrypting identical plaintext with the same key. The FC-type may influence how the data is handled within the encryption process, potentially affecting prioritization or specific processing steps.

In some implementations, the AES-GCM instance may begin by combining the IV with a counter value to create a unique input for each block encryption. This combined value may then be encrypted using the AES algorithm with the provided key. The resulting output may be XORed with the plaintext to produce the ciphertext. Simultaneously, the instance may perform Galois field multiplication operations to generate an authentication tag, which can verify the integrity and authenticity of the encrypted data. The FC-type may be used to determine how the encrypted data and authentication tag are packaged or transmitted, aligning with the requirements of the specific TLP sub-stream associated with that FC-type.

The multiplexer 348 aggregates the outputs from the different instances into a single data stream, which then passes through output logic 350 to produce the final output of the cryptographic component 324. In some implementations, the output logic 350 may perform several functions to prepare the encrypted data for transmission or storage. It may format the encrypted data according to the specific requirements of the PCIe protocol, potentially adding headers or metadata to facilitate proper handling by downstream components. The output logic 350 may also incorporate the authentication tags generated by the AES-GCM instances into the final output, ensuring that the integrity and authenticity of the encrypted data can be verified by the recipient. In some cases, the output logic 350 may interleave or reorder the encrypted data from different FC-types to optimize data flow in the PCIe system. In some implementations, the output logic 350 may apply any necessary error correction codes or perform final integrity checks before releasing the encrypted data from the cryptographic component 324.

FIG. 3C is a block schematic diagram of an example 352 of a hardware implementation in which an AES-GCM operation is implemented in association with multiple IDE sub-streams and multiple AES-GCM instances, in accordance with the present disclosure. The example 352 represents a hardware implementation for managing and selecting round key candidates in an AES system. In traditional AES implementations, managing multiple sets of round keys for different encryption streams or scenarios can be challenging, often requiring separate hardware instances or complex scheduling mechanisms. This can lead to increased hardware complexity, higher power consumption, and potential bottlenecks in the encryption process.

The system shown in FIG. 3C solves this problem by using a flexible key selection mechanism supported by D-type flip flop (D-FF) arrays 354, represented as blocks in FIG. 3C. Each D-FF array 354 represents an array of D flip-flops storing a 32-bit word. A D flip-flop can store one bit of data; therefore, each 32-bit word requires an array of 32 D flip-flops to hold the entire word. These D-FF arrays 354 are organized to store round key candidates 356 for an AES encryption round. Specifically, the D-FF arrays store multiple copies of round key candidates, allowing fast access and quick switching during key expansion or round key selection operations. As shown, the D-FF arrays 354 are organized to store a set 358 of two copies of a first round key candidate, a set 360 of two copies of a second round key candidate, and a set 362 of two copies of a third round key candidate. Each round key candidate 356 includes four round key words, each round key word stored in a D-FF array 354. This structure allows for the storage of multiple complete sets of round keys for different encryption scenarios or data streams. Additionally, the storage of multiple copies of each round key candidate may facilitate fast key refresh operations.

A round key word is a data unit of a specific bit-width (32 bits in the example 352). Each D-FF array 354 is labeled with a label such as “w(P, A, 0),” “w(NP, B, 2),” and the like. The “w” indicates a 32-bit round key word stored in the D-FF array 354, the first entry in the parentheses (e.g., P, NP, or CPL) indicates a sub-stream associated with the round key candidate 356 to which the round key word belongs, the second entry in the parentheses (e.g., A or B) indicates a copy (e.g., a first copy of the round key candidate is labeled A and a second copy of the round key candidate is labeled B), and the third entry in the parentheses (e.g., 0, 1, 2, or 3) indicates a word index corresponding to the round key word. For example, “w(P, A, O)” represents round key word 0 of sub-stream P, copy A.

The key selection process is facilitated by two multiplexers: a 128-bit multiplexer 364 and a 32-bit multiplexer 366. The 128-bit multiplexer 364 allows for the selection of a complete 128-bit round key from among the different candidate sets. That is, the 128-bit multiplexer 364 selects between different D-FF arrays (candidate round keys) for a particular AES round. Since each round key is 128 bits, each round key is composed of four 32-bit words, each selected from the D-FF arrays of candidate words.

The selection of a round key in the AES process may be accomplished through a combination of the 128-bit multiplexer 364 and the 32-bit multiplexer 366. The 128-bit multiplexer 364 may select a complete 128-bit round key from the available round key candidates stored in the D-FF arrays. This selection may be based on various factors such as the current round of encryption, the specific sub-stream being processed, and the copy of the round key candidate being used. Once a 128-bit round key is selected, the 32-bit multiplexer 366 may further refine the selection by choosing individual 32-bit words from the selected round key. This two-stage selection process may allow for flexible and efficient access to the required round key data during the AES encryption or decryption operations.

In some implementations, the selection of round keys and words may be further optimized to enhance the efficiency and flexibility of the AES encryption process. The system may employ a hierarchical selection mechanism that takes into account multiple factors to determine the appropriate round key and word for each stage of the encryption.

For example, the 128-bit multiplexer 364 may use a combination of the current round number, the FC-type of the data being processed, and a key version identifier to select the appropriate 128-bit round key. This selection process may be implemented using a lookup table or a series of logical operations that map these input parameters to the correct set of D-FF arrays 354 containing the desired round key candidate.

In some cases, the system may implement a round key rotation scheme, where different copies of the round key candidates are used in a predetermined sequence to enhance security. For instance, the system may alternate between copy A and copy B of a round key candidate for successive blocks of data within the same encryption stream. This rotation may be achieved by incorporating a block counter or other temporal factor into the selection logic of the 128-bit multiplexer 364.

The 32-bit multiplexer 366 may further refine the selection process by choosing individual words from the selected 128-bit round key. This selection may be based on the specific operation being performed within the AES round. For example, in the AddRoundKey step of AES, each 32-bit word of the state may be XORed with a corresponding 32-bit word of the round key. The 32-bit multiplexer 366 may sequentially select each of the four words of the round key in turn, synchronizing with the AES round operations.

In some implementations, the system may support parallel processing of multiple data streams. For example, while one encryption stream is using words from copy A of a round key candidate, another stream may simultaneously access words from copy B. This parallel access may be facilitated by providing separate control signals to the 128-bit and 32-bit multiplexers for each encryption stream.

Some implementations of the system may also implement a dynamic key update mechanism. In this scenario, new round key candidates may be generated and stored in the D-FF arrays 354 while existing encryption operations are ongoing. The multiplexer selection logic may then be updated to use the new key material for subsequent encryption operations without interrupting current processes. For instance, consider a case where the system is processing three different data streams: a Posted (P) stream, a Non-Posted (NP) stream, and a Completion (CPL) stream. The 128-bit multiplexer 364 may select the round key candidate for the P stream from the set 358, the NP stream from the set 360, and the CPL stream from the set 362. Within each stream, the system may alternate between copies A and B of the round key candidates.

As a specific example, during the first round of encryption for the P stream, the 128-bit multiplexer 364 may select the round key candidate from set 358, copy A. The 32-bit multiplexer 366 may then sequentially select words w(P, A, 0), w(P, A, 1), w(P, A, 2), and w(P, A, 3) for use in the AES round operations. For the next block of data in the P stream, the system may switch to copy B, selecting words w(P, B, 0) through w(P, B, 3). Simultaneously, for the NP stream, the system may select the round key candidate from set 360, starting with copy B and words w(NP, B, 0) through w(NP, B, 3), and then switching to copy A for the next data block.

This flexible selection mechanism may allow the system to efficiently manage multiple encryption streams, support rapid key rotation, and facilitate seamless key updates, all while maintaining high throughput and low latency in the encryption process.

The 128-bit round key selection and 32-bit word selection may be integral parts of the AES process. In each round of AES, a round key is combined with the intermediate state of the data being encrypted or decrypted. The 128-bit selection may provide the complete round key for a given round, while the 32-bit selection may allow for more granular operations within the round. For example, in the AddRoundKey step of AES, each 32-bit word of the state may be XORed with a corresponding 32-bit word of the round key. The 32-bit multiplexer may facilitate this operation by providing the specific words needed at each step. Additionally, this architecture may support parallel processing, as different parts of the AES algorithm may simultaneously access different portions of the round key, potentially improving the overall speed and efficiency of the encryption process.

The D-FF arrays may allow for rapid switching between different encryption keys or rounds, which may be necessary when processing multiple data streams or implementing different security policies. However, the D-FF arrays may be an inefficient use of hardware area. Additionally, multiplexers and demultiplexers may be inefficient from a timing perspective as well. To facilitate a more space-efficient and/or time-efficient AES operation, some implementations described herein use dual-port memory devices for storing round key candidates. The dual-port memory devices may include DP SRAM devices and/or DP RF devices.

FIG. 4 is a block schematic diagram showing an example system 400 in which an AES-GCM operation is implemented in association with multiple IDE sub-streams and a single AES-GCM instance, in accordance with the present disclosure. The system 400 comprises a cryptographic component 402 that includes an AES-GCM instance 404 and a memory 406. The cryptographic component 402 may be implemented using one or more processing units, such as a processor 220 (e.g., an FPGA or an ASIC), as described in relation to device 200 in FIG. 2. The memory 406 may be implemented using various types of memory devices, such as random access memory, read-only memory, or other types of memory as described for memory 230 in FIG. 2. The memory 406 may include a plurality of memory devices, such as dual-port memory devices. In some implementations, these may be DP SRAM devices or DP RFs. The use of dual-port memory devices allows for simultaneous writing of new round keys and reading of existing round keys, which can significantly improve the efficiency of the encryption process.

In operation, the system 400 receives input data 408 that may include multiple FC-types associated with different IDE sub-streams. The FC-types may include, for example, NP, P, and CPL. The ability to handle multiple data types allows the system to process various encryption scenarios efficiently, addressing the need for flexibility highlighted in the discussion of FIG. 3C.

The input data 408 is processed by input logic 410 within the cryptographic component 402. The input logic 410 may be implemented using hardware, firmware, or a combination of hardware and software, and may include one or more processors capable of being programmed to perform the function of data input processing. In some implementations, the input logic 410 may determine different addresses of the memory 406 for storing round keys associated with different data types or encryption scenarios. The input logic 410 also may determine which portions of the incoming data packets to route to the AES-GCM instance 404. For example, a TLP may include header information that is not to be encrypted. The input logic 410 may separate the header information from the payload, which is to be encrypted, and cause the header information to bypass the AES-GCM instance 404.

In some implementations the system 400 uses only a single AES-GCM instance 404 to process multiple IDE sub-streams. This approach contrasts with the multiple AES-GCM instances shown in FIG. 3B and addresses the inefficiencies of the D-FF array and multiplexer system described in FIG. 3C. The AES-GCM instance 404 receives AES input 412, which includes multiple tuples, each tuple including an encryption key, an IV, and an FC-type indication: (Key₁, IV₁, P), (Key₂, IV₂, NP), and (Key₃, IV₃, CPL).

The round key management system described herein enables the use of a single instance of the AES-GCM to process multiple sub-streams by efficiently organizing and storing round keys in a dual-port memory structure. This approach allows for simultaneous access to different sets of round keys, corresponding to various sub-streams, without the need for multiple physical AES-GCM instances. The system may store round keys for different sub-streams (e.g., P, NP, CPL) in separate sections of the memory, with each section containing round keys for multiple rounds of the AES algorithm.

The AES-GCM instance 404 processes data by performing a series of transformations on the input plaintext, using the round keys stored in the dual-port memory. For each round of the AES algorithm, the appropriate round key is retrieved from the memory and combined with the current state of the data. The dual-port memory system allows simultaneous read and write operations. While the AES-GCM instance is reading round keys for the current encryption operation, the system may concurrently update or write new round keys for other sub-streams or future operations.

For example, in a scenario where the system is processing three sub-streams, a Posted (P) sub-stream, a Non-Posted (NP) sub-stream, and a Completion (CPL) sub-stream, the dual-port memory may be organized with separate sections for each sub-stream's round keys. As the AES-GCM instance 404 processes data from the P sub-stream, it may read the required round keys from the P section of the memory using one port. Simultaneously, the AES-GCM instance 404 may use the other port to update round keys in the NP or CPL sections, preparing for upcoming encryption operations on those sub-streams. This parallel access capability may significantly enhance the efficiency of the encryption process, allowing the single AES-GCM instance 404 to switch rapidly between different sub-streams without incurring delays for key loading or updates.

In some implementations, this system may involve generating, using a first encryption key, a first set of round keys for rounds of the AES algorithm, and generating, using a second encryption key, a second set of round keys for the rounds of the AES algorithm. These round keys may be stored in different addresses of the memory 406, with the addresses determined based on factors such as the round of the AES algorithm associated with each round key, the key used to generate the round key, and the indexes of words included in the round key.

After processing by the AES-GCM instance 404, the encrypted data passes through output logic 414. The output logic 414 may retrieve the encrypted data from the memory 406 and prepare it for output from the cryptographic component 402. In some implementations, the output logic 414 may determine a round for the AES algorithm, a key for the round, and an index for a specific word of a round key, and then obtain the required word from the memory 406 to complete the encryption process.

The output logic 414 may perform several important functions in the cryptographic processing system. In some implementations, the output logic 414 may be responsible for retrieving the encrypted data from the memory 406 and preparing it for transmission or further processing outside the cryptographic component 402. This preparation may involve formatting the encrypted data according to specific protocols or standards required by the receiving system or network.

The output logic 414 may also handle the final stages of the encryption process. For instance, it may determine the appropriate round for the AES algorithm, select the correct key for that round, and identify the index for a specific word of the round key. Using this information, the output logic 414 may then obtain the required word from the memory 406 to complete the encryption process. This capability allows the output logic 414 to fine-tune the encryption output based on the specific requirements of the data stream or security protocol in use.

In some cases, the output logic 414 may perform additional operations on the encrypted data. For example, it may append authentication tags generated by the AES-GCM process to the encrypted data, ensuring that the recipient can verify the integrity and authenticity of the received information. The output logic 414 may also handle the interleaving of encrypted data from different sub-streams (e.g., P, NP, CPL) if required by the output interface or downstream processing components.

As an example, consider a scenario where the system is processing both Posted (P) and Non-Posted (NP) data streams. The output logic 414 may retrieve the encrypted P stream data from one section of the memory 406 and the encrypted NP stream data from another section. It may then interleave these two streams according to a predetermined pattern or based on priority flags associated with each data packet. The output logic 414 may also add necessary headers or metadata to each packet, indicating its stream type and any other relevant information for downstream processing or routing.

The system 400 may support various alternative embodiments and implementations. For example, in some cases, round keys generated for a specific round of the AES algorithm may be stored on a particular memory device of the plurality of memory devices within memory 406. This organization may enable the single AES-GCM instance 404 to be used efficiently for the round keys for that specific round of the AES algorithm.

Storing round keys for a specific round on a particular memory device may lead to efficient use of the AES-GCM instance in several ways. By organizing round keys in this manner, the system may optimize memory access patterns and reduce latency in retrieving the necessary keys during the encryption process. In some implementations, this organization may allow for parallel access to round keys for different rounds. For example, while the AES-GCM instance is processing one round of encryption and accessing the corresponding round key from one memory device, the system may simultaneously prefetch the next round key from another memory device. This parallel access may help to minimize delays between rounds and maintain a continuous flow of data through the encryption pipeline.

The dedicated storage of round keys for specific rounds on particular memory devices may also enable more efficient use of cache memory. By localizing the round keys for each round, the system may improve cache hit rates and reduce the need for time-consuming memory fetches from higher-level storage. This optimization may be particularly beneficial in scenarios where the AES-GCM instance is processing multiple data streams or performing repeated encryption operations with the same key.

Furthermore, this storage strategy may facilitate the implementation of round-specific optimizations. For instance, the system may employ different memory types or configurations for storing round keys of different rounds based on their access patterns or criticality to the encryption process. Early rounds of the AES algorithm may require faster access times, and their round keys may be stored in high-speed memory devices, while later rounds may use slightly slower but more power-efficient memory.

In some cases, storing round keys for a specific round on a particular memory device may simplify the control logic required to manage the encryption process. The AES-GCM instance may use a straightforward addressing scheme to access the appropriate round keys, potentially reducing the complexity of the key retrieval mechanism and improving overall system reliability. This organization may also support more flexible key management strategies. For example, the system may update or rotate round keys for specific rounds without affecting the keys for other rounds, allowing for granular key management and enhanced security practices

The system 400 may provide several advantages over the implementations shown in FIGS. 3B and 3C. By using a single AES-GCM instance with an efficient memory management system, implementations of the system 400 may reduce hardware complexity and power consumption. The use of dual-port memory devices allows for simultaneous key schedule updates and round key retrieval, potentially improving the overall speed of encryption operations. Furthermore, the ability to handle multiple IDE sub-streams with a single instance provides greater flexibility and scalability, addressing the challenges of managing multiple encryption scenarios or data streams.

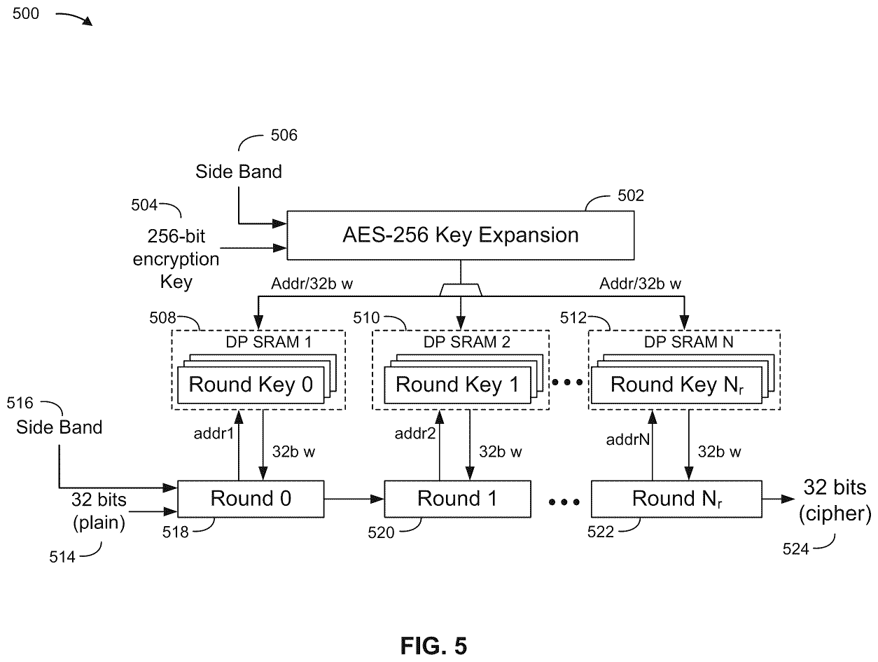

FIG. 5 is a block schematic diagram of an example 500 of an AES key expansion operation using DP SRAM instances, in accordance with the present disclosure. This implementation addresses the technical challenges of managing multiple sets of round keys for different encryption streams or scenarios, which traditionally required separate hardware instances or complex scheduling mechanisms.

As shown, a key expansion component 502 receives a 256-bit encryption key 504 and side band input 506. The key expansion component 502 is configured to generate round keys for multiple rounds of the AES algorithm. The key expansion component 502 may implement the key expansion algorithm as described in the AES standard, which involves a series of operations such as byte substitution, word rotation, and XOR operations with round constants.

In some implementations, the key expansion component 502 may be configured to generate multiple sets of round keys simultaneously, using different encryption keys. This capability allows the system to support multiple encryption streams or scenarios without the need for separate hardware instances for each key set. The side band input 506 may provide additional control signals or parameters to the key expansion module 502, allowing for flexible configuration of the key expansion process. For example, the side band input 506 may indicate the encryption key, an IV, or an FC-type, among other examples.

Multiple DP SRAM units may be used for storing round key candidates, including DP SRAM 1 508, DP SRAM 2 510, and DP SRAM N 512, where N represents the total number of DP SRAM units used. These DP SRAM units serve as storage for the round key candidates generated by the key expansion component 502. The use of dual-port memory devices may allow for simultaneous writing of new round keys and reading of existing round keys, significantly improving the efficiency of the encryption process.

Each DP SRAM unit may be associated with a specific round of the AES algorithm. For example, DP SRAM 1 508 may store round keys for the first round, DP SRAM 2 510 for the second round, and so on. This organization enables efficient access to the required round keys during the encryption process. In some implementations, each DP SRAM unit may store round keys for multiple key sets, with the specific storage locations determined by address signals (shown as “addr”) provided to the DP SRAM units.

The encryption process begins with plain data input 514 and side band input 516 entering the round 0 operation 518. The side band inputs 506 and 516 may serve different purposes and provide additional information or control signals to different parts of the encryption process. The side band input 506, which is provided to the key expansion component 502 along with the 256-bit input key 504, may include additional parameters or control signals that influence the key expansion process. This input may provide information such as a key type or index, which may be used to generate different sets of round keys for multiple encryption streams or scenarios; IV information, which may be incorporated into the key expansion process to enhance security; or FC-type indicators, which may determine how the generated round keys are to be used or stored. On the other hand, the side band input 516 is provided alongside the plain data input 514 to the round 0 operation 518. This side band input may contain information specific to the encryption process itself, such as data stream identifiers, which may help the system determine which set of round keys to use for the current encryption operation; AAD for use in AES-GCM mode, which may be incorporated into the authentication process without being encrypted; or control signals that may influence how the encryption rounds are performed or how the data is processed through the AES algorithm.

The main difference between side band input 506 and side band input 516 may lie in their timing and purpose within the overall encryption process. Side band input 506 may be used primarily for key expansion and round key generation, while side band input 516 may be more directly related to the actual encryption of the plain data input. This separation allows for flexible configuration of both the key expansion and encryption processes, potentially enabling the system to handle multiple encryption scenarios or data streams efficiently.

The round 0 operation 518 retrieves the corresponding round key from DP SRAM 1 508 using an address signal (addr1). This address signal may be generated based on factors such as the current encryption stream, the key set being used, and the specific word of the round key required. The address signal may be generated using a combination of factors to ensure efficient and accurate retrieval of the required round key words. In some implementations, the system may use a multi-part addressing scheme that incorporates information about the current encryption stream, the key set being used, and the specific word of the round key required.

For example, the address signal may be constructed by concatenating bit fields representing each of these factors. The most significant bits may represent the encryption stream identifier, followed by bits indicating the key set, then the round number, and finally the least significant bits may indicate the specific word within the round key. This approach may allow for flexible addressing that can accommodate multiple encryption streams and key sets while maintaining efficient access to individual round key words.

In some cases, the system may employ a more complex addressing scheme that uses hash functions or lookup tables to generate the address signal. For instance, the encryption stream identifier and key set information may be used as inputs to a hash function, with the output serving as a base address. The round number and word index may then be used as offsets from this base address. This method may provide additional security by obfuscating the relationship between the address and the stored round key words.

As an example, consider a system processing three encryption streams (A, B, and C) with two key sets each. The address signal for the second word of the third round key for stream B's first key set might be generated as follows:
stream identifier: B=01 (2 bits),
key set: 1=0 (1 bit),
round number: 3=011 (3 bits), and
word index: 2=10 (2 bits),
   where the resulting address signal might be: 0100110110.

In another implementation, the system may use a more dynamic addressing scheme that adapts to the current encryption workload. For instance, frequently used round keys may be assigned to lower address ranges for faster access. The address generation logic may track usage patterns and periodically reorganize the address assignments to optimize performance. In this case, the address signal may include additional bits that represent priority or frequency of use, which are then translated into physical memory addresses by the memory controller.

The output of round 0 operation 518 feeds into round 1 operation 520, which retrieves its round key from DP SRAM 2 510 using an address signal (addr2). This process continues through subsequent rounds, with each round operation retrieving its respective round key from the corresponding DP SRAM unit. The final round, represented by round Nr operation 522, produces the cipher data output 524.

In some implementations, the system may support parallel processing of multiple data streams. For example, while one encryption stream is retrieving a round key from a DP SRAM unit, another stream may be writing new round key candidates to a different DP SRAM unit. This parallel processing capability can significantly improve the overall throughput of the encryption system.

The use of DP SRAM units also allows for dynamic updating of round keys without interrupting ongoing encryption operations. For example, the key expansion component 502 could generate a new set of round keys and write them to the DP SRAM units using one port, while the round operations continue to read the current set of round keys using the other port. This feature enables seamless key rotation or updates in long-running encryption processes.

In some implementations, the system may include additional features to enhance security or performance. For example, the system may incorporate a key schedule array structure within the DP SRAM units, similar to the one described in relation to FIG. 4. This structure could allow for efficient storage and retrieval of multiple round keys for different key indexes, further enhancing the system's ability to handle multiple encryption scenarios. In some implementations, the system may include error detection and correction mechanisms for the stored round keys. For instance, error-correcting code (ECC) could be implemented within the DP SRAM units to protect against bit flips or other memory errors that could compromise the integrity of the round keys.

The system illustrated in FIG. 5 provides a solution to the technical problem of efficiently managing multiple sets of round keys for AES encryption. By utilizing DP SRAM instances and organizing the storage and retrieval of round keys in a structured manner, the system achieves improved performance, reduced hardware complexity, and enhanced flexibility compared to traditional implementations. This approach enables the efficient handling of multiple encryption streams or scenarios using a single hardware instance, addressing the challenges of scalability and resource utilization in modern cryptographic systems.

The AES-GCM employs both the AES Cipher( ) and KeyExpansion( ) algorithms as defined in the AES standard. In AES-GCM, the Cipher and Decipher operations are symmetric, meaning that both encryption and decryption processes utilize the same set of keys and initialization vectors (IVs). Specifically, the AES-GCM Cipher and Decipher pair share the identical (AES Key, GCM IV) combination, ensuring that the data can be correctly encrypted and subsequently decrypted. The AES-GCM Cipher and Decipher algorithms are logically equivalent, which implies that the operations they perform mirror each other in terms of processing, although one encrypts the data and the other decrypts it. However, the AES-GCM Decipher operation requires the ciphered data to be presented in the correct order to function accurately.

The AES algorithm introduces the concept of a “round” in its Cipher( ) and KeyExpansion( ) algorithms. In the Cipher( ) operation, each data block undergoes a series of Nᵣ+1 rounds, where Nᵣ represents the number of rounds specified by the AES standard depending on the key length. During each round, an AddRoundKey( ) operation is applied to the initial plaintext and subsequent intermediate data blocks of 128 bits. Concurrently, the KeyExpansion( ) algorithm generates a series of 4*(Nᵣ+1) 32-bit words, which are subsequently used as round keys for each of the Nᵣ+1 rounds. The AES standard refers to a “word” as a 32-bit data unit, and it should be noted that the Cipher( ) process involves more than just the AddRoundKey( ) operation within each round.

The AES Cipher( ) algorithm incorporates several additional operations within each round, including the SBox( ), ShiftRows( ), MixColumns( ), and AddRoundKey( ) functions. Similarly, the KeyExpansion( ) algorithm utilizes Sbox( ), SubWord( ), and RotWord( ) operations to generate the round keys. For decryption, the InvCipher( ) operation applies the inverse functions, namely InvShiftRows( ), InvSBox( ), InvMixColumns( ), and AddRoundKey( ), to reverse the encryption process and retrieve the original plaintext.

AES-GCM is compatible with three members of the Rijndael family, which are specified in the AES standard as AES-128, AES-192, and AES-256. These variations differ in the key length used for encryption and decryption, with AES-128 using a 128-bit key and 10 rounds (Nᵣ=10), AES-192 using a 192-bit key and 12 rounds (Nᵣ=12), and AES-256 using a 256-bit key and 14 rounds (Nᵣ=14). Each of these algorithms processes data in blocks of 128 bits, with the number of rounds directly determined by the bit length of the associated cryptographic key.

In the context of PCIe, the IDE mechanism establishes an IDE Stream between two ports. When AES-GCM is employed within such an IDE Stream, it may be important to maintain TLPs in order, as the AES-GCM Decipher requires ordered data to function correctly. However, certain situations necessitate the re-ordering or bypassing of TLPs to avoid deadlocks, which is managed through different types of FC credit types, namely posted (P), non-posted (NP), and completion (CPL) TLPs. The IDE architecture introduces the concept of sub-streams, each of which accommodates only one type of FC TLP, ensuring that TLP traffic is maintained in order between IDE partner ports.

Given that AES-GCM can only process ordered data, the presence of multiple FC types implies the need for multiple virtual instances of AES-GCM to handle different TLP types. However, implementing multiple physical instances of AES-GCM logic is not area-efficient on an ASIC due to the increased gate count and transistor usage. Therefore, it is desirable to implement a single AES-GCM instance in hardware that can handle all TLP types. Although all virtual AES-GCM instances are logically equivalent, each has a unique key, and only one AES-GCM instance (data path) is active at any given time.

Switching between IDE sub-streams effectively involves switching between different (AES Key, GCM IV) pairs, which differentiate the equivalent virtual AES-GCM instances. Within the AES process, this switching equates to selecting between different AES round key candidates, each generated by the AES KeyExpansion( ) function from the corresponding AES Key. For the GCM mode, switching corresponds to selecting the sub-stream's current Counter Block Flow Control Type (CBFC-Type), where each initial counter block is derived from the corresponding IV. Implementations of the disclosure may include managing and selecting AES round key candidates using DP SRAM and DP RFs, which may be advantageous for ASIC implementations by reducing the number of physical AES-GCM instances required and optimizing the PCIe IDE logic block architecture.

The KeyExpansion( ) formula of the AES algorithm may be written as follows:

$${w}_{i} = \{ \begin{matrix}{k}_{i} & if i < {N}_{k} \\ {w}_{i - {N}_{k}} ⊕ SubWord ( RotWord ( {w}_{i - 1} ) ) ⊕ Rcon [ i / {N}_{k} ] & if i \geq {N}_{k} , i mod {N}_{k} = 0 \\ {w}_{i - {N}_{k}} ⊕ SubWord ( {w}_{i - 1} ) & if i \geq {N}_{k} , i mod {N}_{k} = 4 , {N}_{k} > 6 \\ {w}_{i - {N}_{k}} ⊕ {w}_{i - 1} & Otherwise\end{matrix}$$

where Nᵣ is the number of the AES round, i∈N, 0≤i≤4Nᵣ−1,
Nₖ is the number of 32 bit word of the AES unique key,
[k₀, k₁, . . . k_{N}_{_{K-1}}] is the AES unique key, kₙ is a 32 bit word, and, wᵢ is the i^{th} 32 bit word element of the key schedule words array of 4Nᵣ−1 elements. The KeyExpansion( ) formula is applicable to all types of AES algorithms such as, for example, AES-128 where Nk=4, Nr=10; AES-192 where Nk=6, Nr=12; and AES-256 where Nk=8, Nr=14.

For AES-256, the number of the AES round Nᵣ=15, i∈N, 0≤i≤59, the number of 32 bit words of the AES unique key Nₖ=8, [k₀, k₁, k₂, k₃, k₄, k₅, k₆, k₇] is the 256 bit AES unique key, kₙ is a 32 bit word, and wᵢ is the i^{th} 32 bit word element of the key schedule words array of 60 elements (in which there are 4 words per round). The following constants may be defined:

$$Rcon [ 1 ] = [ 01 , 00 , 00 , 00 ]$$

$$Rcon [ 2 ] = [ 02 , 00 , 00 , 00 ]$$

$$Rcon [ 3 ] = [ 04 , 00 , 00 , 00 ]$$

$$Rcon [ 4 ] = [ 08 , 00 , 00 , 00 ]$$

$$Rcon [ 5 ] = [ 10 , 00 , 00 , 00 ]$$

$$Rcon [ 6 ] = [ 20 , 00 , 00 , 00 ]$$

$$Rcon [ 7 ] = [ 40 , 00 , 00 , 00 ]$$

and the two transformations on words in the above KeyExpansion( ) formula may be defined as follows:

$$RotWord ( [ {a}_{0} , {a}_{1} , {a}_{2} , {a}_{3} ] ) = [ {a}_{1} , {a}_{2} , {a}_{3} , {a}_{0} ] , where {a}_{n} is a byte ; and$$

$$SubWord ( [ {a}_{0} , {a}_{1} , {a}_{2} , {a}_{3} ] ) = [ SBox ( {a}_{0} ) , SBox ( {a}_{1} ) , SBox ( {a}_{2} ) , SBox ( {a}_{3} ) ] ,$$

where aₙ is a byte. The SBox(aₙ) transforms a byte to a different byte according to a fix substitution table. The detail is defined in the AES standard.

The following formula is classifying the generic KeyExpansion( ) algorithm formula according to 4 scenarios, corresponding to 4 conditions in the generic formula. The purpose of introducing the 4 scenarios S0˜S3 is to classify the words of a set of round keys in the context of word value determination under AES-256. Note that Nₖ is replaced with 8, the number of words in a key. In summary of the above, for AES-256, each wᵢ is determined at a given AES-256 unique key, i.e., [k₀, k₁, k₂, k₃, k₄, k₅, k₆, k₇], under 4 scenarios:

$$\{ \begin{matrix}{S}_{0} & Scenario 0 & if i < 8 \\ {S}_{1} & Scenario 1 & if i \geq 8 , i mod 8 = 0 \\ {S}_{2} & Scenario 2 & f i \geq 8 , i mod 8 = 4 \\ {S}_{3} & Scenario 3 & Otherwise\end{matrix} .$$

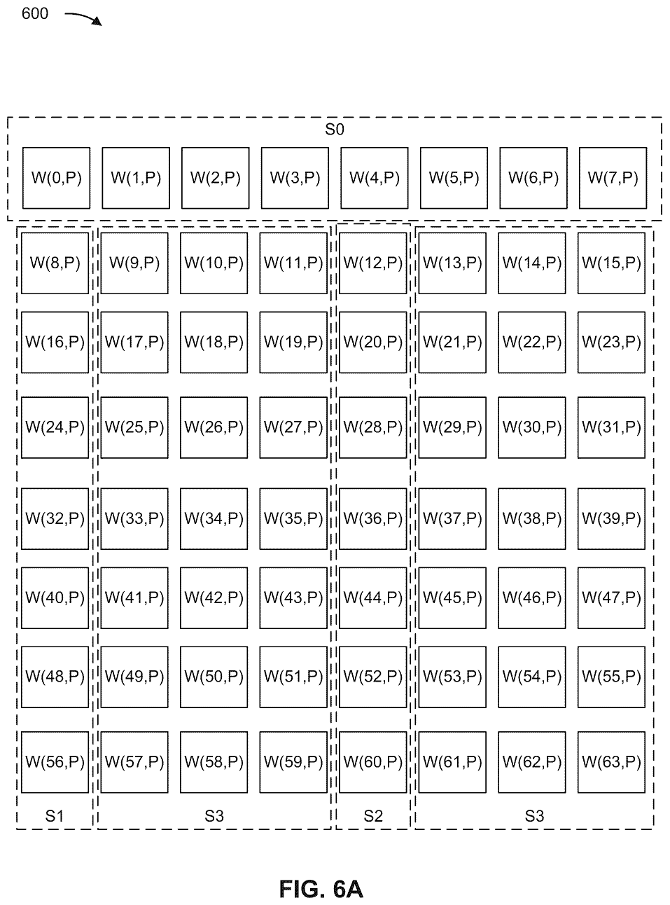

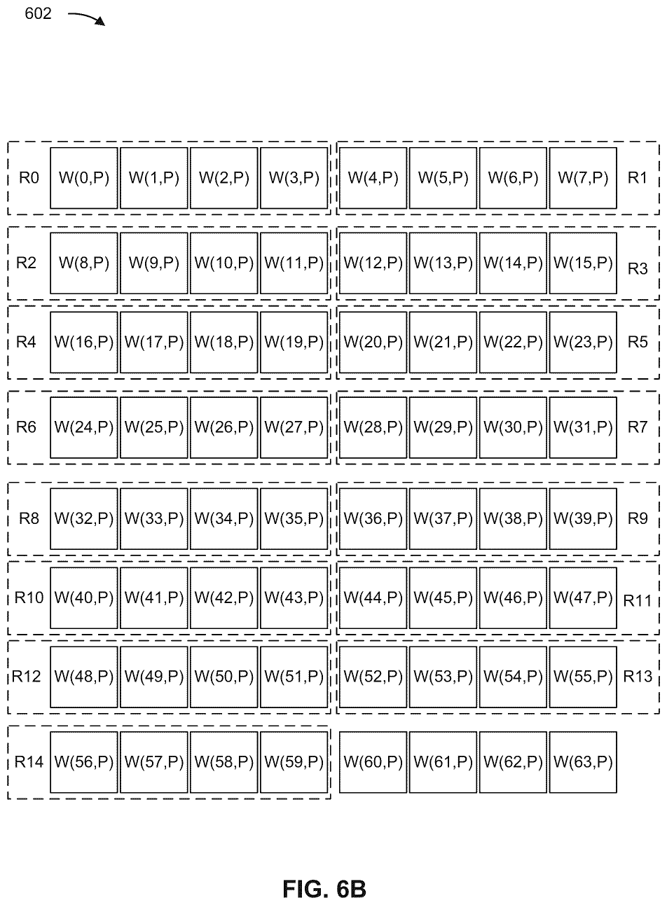

In some implementations, a cryptographic component may prepare the key schedules for 3 given AES-256 keys, indexed with P, NP, and CPL. Using the AES-256 key of the index P as example, the key schedule array can be visualized as shown in FIG. 6A.

FIGS. 6A and 6B are block schematic diagrams showing example key schedule arrays 600 and 602, respectively, associated with an AES-GCM key expansion operation associated with multiple IDE sub-streams, in accordance with the present disclosure. The example key schedule array 600 represents scenario classification for words in a set of round keys generated with a given key. The scenarios may be used for word value determination in the context of AES KeyExpansion( ) algorithm under AES-256.

The cryptographic component may determine each word of a set of round keys. According to the formula, the first row of the array 600 is given as the AES-256 unique key. Each of the remaining elements may be progressively determined with formulae associated with its array index (0, 1, 2, . . . , 59) and scenario (S₀, S₁, S₂, and S₃). For example:

$${S}_{1} : {w}_{( 8 , P )} = {w}_{( 0 , P )} ⊕ SubWord ( RotWord ( {w}_{( 7 , P )} ) ) ⊕ Rcon [ 1 ]$$

$${S}_{2} : {w}_{( 12 , P )} = {w}_{( 4 , P )} ⊕ SubWord ( {w}_{( 11 , P )} ) ,$$

$${S}_{3} : {w}_{( 9 , P )} = {w}_{( 1 , P )} ⊕ {w}_{( 8 , P )}$$

where an AES-256 round key is 128 bits, 4 of 32-bit words from the key schedule array. The array 602 illustrates the 15 AES-256 round keys, showing word and round key relationship, under AES-256, in which every four words is a round key, sequentially, as implied by the index of w. In the key schedule array 602, I—is index of keys (e.g., P, NP, CPL) and i is the number index (0, 1, 2, . . . ) of the round (e.g., the position in the array). Note that only 60 words from the key schedule array 602 are used for 15 rounds of the AES-256.

In various implementations, certain properties of any element w_{(i,I)} of the AES-256 key schedule array 602 associated with the AES-256 key indexed with I (i∈N, i∈[0,59], I∈(P, NP, CPL)) can be determined and can be used for memory address mapping as set forth below:
Value→: 32-bit Data to write to the DP SRAM
   Rₙ→: DP SRAM Logical Instance Index
      I→: AES Key Association Address Offset
         i→: AES Round Key Word Address Offset
            where a DP SRAM logical instance index can be differentiated with “write enable” pin of each instance's write port. The absolute address of each 32-bit value data to write to can be generated as:

### ADDRESS=AES Key Association Address Offset+AES Round Key Word Address Offset.

According to the AES standard, internally, the algorithms for the AES block ciphers are performed on a two-dimensional (four-by-four) array of bytes called the state. The last step of each round is AddRoundKey( ). The algorithm may use the current state (128-bit) to XOR with the RoundKey (128-bit), i.e., certain 4 words from the key schedule array associated with the current AES key. The AddRoundKey( ) algorithm can be illustrated as:

$$[ {s}_{0 , c}^{′} , {s}_{1 , c}^{′} , {s}_{2 , c}^{′} , {s}_{3 , c}^{′} ] = [ {s}_{0 , c} , {s}_{1 , c} , {s}_{2 , c} , {s}_{3 , c} ] ⊕ [ {w}_{( 4 {R}_{n} + c )} ]$$

where: s_{n,c} is a byte and 0≤c<4 is a column index. The properties of the needed key schedule array word w_{(i,I)} can be determined as follows:
   Rₙ←: Round Index Is Fixed in Each Round
      I←: AES Key Index Is Given For A state (128-bit data block)
         i←: 4Rₙ+C
   Value←: 32-bit Data Read From DP SRAM (Addr from above 3)
      where the round index is used to calculate the word index, in the context of a whole set of round keys, generated with a given key. Rₙ is fixed for each round and is therefore fixed for the memory instance associated with that round. Thus, after using Rₙ to determine the memory instance, it may be irrelevant to determine the word address within that memory instance. Accordingly, the key index and word indexes may be used to determine an address of a word, and the Rₙ may be excluded, leaving only the c part as relevant.

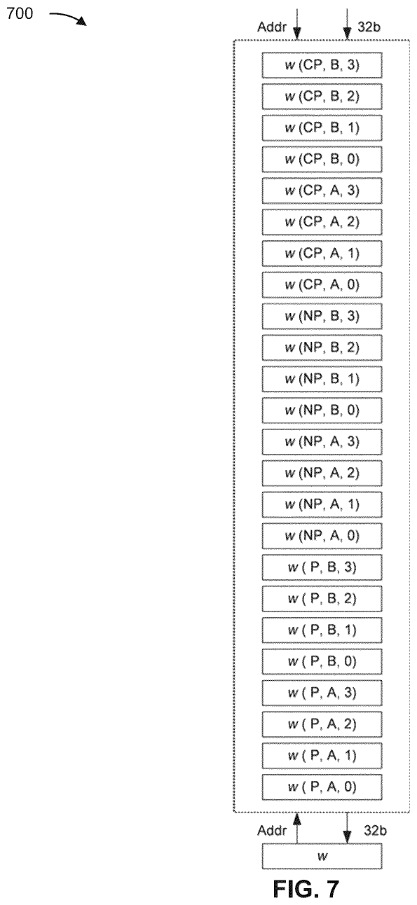

FIG. 7 is a block schematic diagram showing an example memory structure 700 for a hardware implementation in which an AES-GCM operation is implemented in association with multiple IDE sub-streams and a single AES-GCM instance, in accordance with the present disclosure. The memory structure 700 may include a DP SRAM and/or a DP RF. The memory structure 700 is organized to efficiently manage round keys for multiple AES keys and rounds, facilitating the implementation of AES-GCM operations for multiple IDE sub-streams using a single AES-GCM instance.

The memory structure 700 comprises a series of memory locations, each represented by a rectangular box. Each memory location is designed to store a 32-bit word, denoted by “w” followed by parameters in parentheses. These parameters indicate the AES key index, round number, and word index within the round key. The memory structure is divided into three main sections, each corresponding to a different AES key index: P, NP, and CP. Within each section, the round keys for multiple rounds are stored sequentially, allowing for efficient access during the encryption process.

For each key index, the round keys are organized in a specific pattern. The memory locations store words w(Key_Index, A, 0) to w(Key_Index, A, 3) for round A, followed by w(Key_Index, B, 0) to w(Key_Index, B, 3) for round B, and so on. This organization allows for quick retrieval of complete round keys, as each set of four consecutive words forms a 128-bit round key used in a specific round of the AES algorithm. The memory structure 700 includes an address input labeled “Addr” at both the top and bottom, which is used to access specific memory locations. The “32b” label at the top and bottom indicates that each memory location stores a 32-bit word, aligning with the AES algorithm's word size requirements.

At the bottom of the memory structure 700, there is an additional box labeled “w” with an “Addr” input and “32b” output. This represents the read operation, where a specific 32-bit word can be retrieved from the memory structure using its address. This feature may allow for efficient access to individual words of round keys, which can be particularly useful in implementations where only specific portions of a round key are needed at a time. The organization of the memory structure 700 may enable simultaneous access to different round keys, supporting parallel processing of multiple data streams or efficient key rotation in long-running encryption processes.

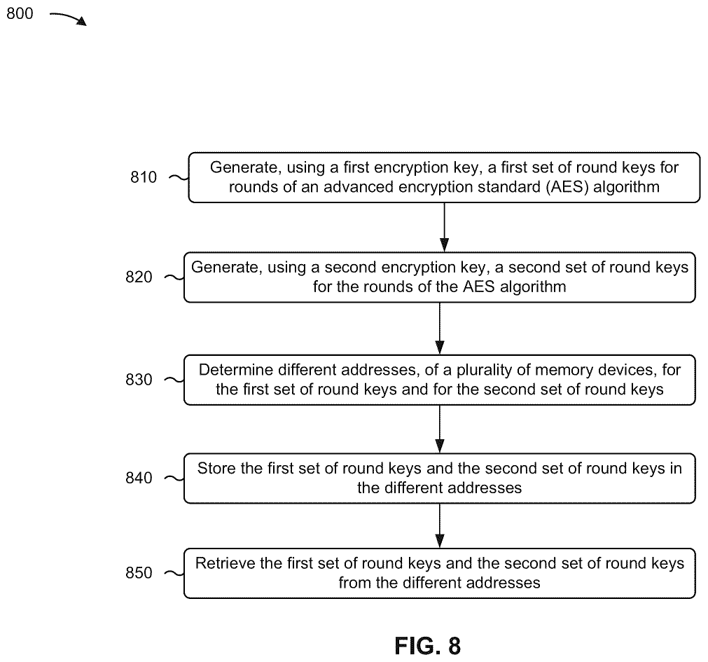

FIG. 8 is a flow diagram of an example process 800 of storing and providing access to round keys using dual port memory devices, in accordance with the present disclosure. In some implementations, one or more process blocks of FIG. 8 may be performed by a cryptographic component such as, for example, the cryptographic component 402 shown in FIG. 2. In some implementations, one or more process blocks of FIG. 8 may be performed using one or more components of device 200, such as processor 220, memory 230, storage component 240, input component 250, output component 260, and/or communication interface 270.

As shown in FIG. 8, process 800 may include generating, using a first key, a first set of round keys for rounds of an AES algorithm (block 810). For example, the device may generate, using a first key, a first set of round keys for rounds of an AES algorithm, as described above.

Process 800 may further include generating, using a second key, a second set of round keys for the rounds of AES algorithm (block 820). For example, the device may generate, using a second key, a second set of round keys for the rounds of AES algorithm, as described above. In some implementations, the first set of round keys and the second set of round keys are generated as part of AES-GCM. In some implementations, round keys, of the first set of round keys and of the second set of round keys, that are generated for a round of AES algorithm are stored on a particular memory device of the plurality of memory devices, and storing the round keys, generated for the round of AES algorithm, on the particular memory device may enable one AES-GCM instance to be used for the round keys for the round of AES algorithm.

Process 800 may further include determining different addresses, of a plurality of memory devices, for the first set of round keys and for the second set of round keys (block 930). For example, the device may determine different addresses, of a plurality of memory devices, for the first set of round keys and for the second set of round keys, as described above. In some implementations, first addresses of a first round key, of the first set of round keys, may be determined based on a round of AES algorithm associated with the first round key, the first key, and first indexes of words included in the first round of key. In some implementations, second addresses of a second round key, of the second set of round keys, may be determined based on a round of AES algorithm associated with the second round key, the second key, and second indexes of words included in the second round of key. In some implementations, process 800 may include determining an address of a word of the first round key based on a round of AES algorithm associated with the first round key, the first key, and an index of the word included in the first round of key.

Process 800 may further include storing the first set of round keys and the second set of round keys in the different addresses (block 840). For example, the device may store the first set of round keys and the second set of round keys in the different addresses, as described above. In some implementations, the first round key may be stored in a memory device, of the plurality of memory devices, using a first port of the memory device. The memory device may be a dual port memory device that includes the first port and a second port. The memory device may include an SRAM. In some implementations, the device may include a DP SRAM. In some implementations, the memory device may include an RF. In some implementations, the memory device may include a DP RF. In some implementations, round keys, of the first set of round keys and of the second set of round keys, that are generated for a first round of AES algorithm may be stored on a first memory device of the plurality of memory devices, and round keys, of the first set of round keys and of the second set of round keys, that are generated for a second round of AES algorithm may be stored on a second memory device of the plurality of memory devices.

Process 800 may further include retrieving the first set of round keys and the second set of round keys from the different addresses (block 850). For example, the device may retrieve the first set of round keys and the second set of round keys from the different addresses, as described above. In some implementations, the first round key may be retrieved from the first memory device using the second port of the memory device. Process 800 may further include receiving a request to perform an AES algorithm on data using a word of the first round key; determining a round for the AES algorithm, a key for the round, and an index for the word; obtaining from the memory device, via the second port, the word; and performing the AES algorithm on the data to obtain encrypted data.

In some implementations one logical DP SRAM or RF instance may correspond to one respective AES round. The write port of the DP SRAM or the RF instance may provide access to the AES KeyExpansion( ) algorithm to manage AES Round Key candidates of that AES round. The read port of DP SRAM or RF instance may provide access to the AES round logic to get the selected Round Key and perform the AddRoundKey( ) operation. Round key candidates number scaling, management, and selection may be as convenient as memory mapping.

Some embodiments are described as numbered examples (Example 1, 2, 3, etc.). These are provided as examples only and do not limit the technology disclosed herein.

Example 1 includes a method comprising generating, using a first key, a first set of round keys for rounds of an AES algorithm; generating, using a second key, a second set of round keys for the rounds of AES algorithm; determining different addresses, of a plurality of memory devices, for the first set of round keys and for the second set of round keys, wherein first addresses of a first round key, of the first set of round keys, are determined based on: a round of AES algorithm associated with the first round key, the first key, and first indexes of words included in the first round of key, and wherein second addresses of a second round key, of the second set of round keys, are determined based on a round of AES algorithm associated with the second round key, the second key, and second indexes of words included in the second round of key; storing the first set of round keys and the second set of round keys in the different addresses, wherein the first round key is stored in a memory device, of the plurality of memory devices, using a first port of the memory device, and wherein the memory device is a dual port memory device that includes the first port and a second port; and retrieving the first set of round keys and the second set of round keys from the different addresses, wherein the first round key is retrieved from the first memory device using the second port of the memory device.

Example 2 includes the method of Example 1, wherein the memory device includes a static random access memory.

Example 2 includes the method of Example 1, wherein the memory device includes a register file.

Example 4 includes the method of any of Examples 1-3, wherein round keys, of the first set of round keys and of the second set of round keys, that are generated for a first round of AES algorithm are stored on a first memory device of the plurality of memory devices, and wherein round keys, of the first set of round keys and of the second set of round keys, that are generated for a second round of AES algorithm are stored on a second memory device of the plurality of memory devices.

Example 5 includes the method of any of Examples 1-4, wherein the first set of round keys and the second set of round keys are generated as part of AES-GCM.

Example 6 includes the method of Example 5, wherein round keys, of the first set of round keys and of the second set of round keys, that are generated for a round of AES algorithm are stored on a particular memory device of the plurality of memory devices, and wherein storing the round keys, generated for the round of AES algorithm, on the particular memory device enables one AES-GCM instance to be used for the round keys for the round of AES algorithm.

Example 7 includes the method of any of Examples 1-6, further comprising determining an address of a word of the first round key based on a round of AES algorithm associated with the first round key, the first key, and an index of the word included in the first round of key.

Example 7 includes the method of any of Examples 1-7, further comprising: receiving a request to perform an AES algorithm on data using a word of the first round key; determining a round for the AES algorithm, a key for the round, and an index for the word; obtaining from the memory device, via the second port, the word; and performing the AES algorithm on the data to obtain encrypted data.

Example 8 includes a system comprising: one or more processing units adapted to: generate, using a first key, a first set of round keys for rounds of an AES algorithm; generate, using a second key, a second set of round keys for the rounds of AES algorithm; determine different addresses, of a plurality of memory devices, for the first set of round keys and for the second set of round keys, wherein first addresses of a first round key, of the first set of round keys, are determined based on: a round of AES algorithm associated with the first round key, the first key, and first indexes of words included in the first round of key, and wherein second addresses of a second round key, of the second set of round keys, are determined based on a round of AES algorithm associated with the second round key, the second key, and second indexes of words included in the second round of key; and store the first set of round keys and the second set of round keys in the different addresses, wherein the first round key is stored in a memory device, of the plurality of memory devices, using a first port of the memory device, and wherein the memory device is a dual port memory device that includes the first port and a second port.

Example 10 includes the system of Example 9, wherein the one or more processing units are adapted to retrieve the first set of round keys and the second set of round keys from the different addresses, wherein the first round key is retrieved from the first memory device using the second port of the first memory device.

Example 11 includes the system of either of Examples 9 or 10, wherein the memory device includes a dual-port static random access memory.

Example 12 includes the system of either of Examples 9 or 10, wherein the memory device includes a dual-port register file.

Example 13 includes the system of any of Examples 9-12, wherein the first set of round keys and the second set of round keys are generated as part of AES-GCM.

Example 14 includes the system of Example 13, wherein round keys, of the first set of round keys and of the second set of round keys, that are generated for a round of AES algorithm are stored on a particular memory device of the plurality of memory devices, and wherein storing the round keys, generated for the round of AES algorithm, on the particular memory device enables one physical AES-GCM instance to be used for the round keys for the round of AES algorithm.

Example 15 includes the system of any of Examples 9-14, wherein the one or more processing units are adapted to determine an address of word of the first round key based on a round of AES algorithm associated with the first round key, the first key, and an index of the word included in the first round of key.

Example 16 includes a computer program product comprising: one or more computer readable storage media, and program instructions collectively stored on the one or more computer readable storage media, the program instructions comprising: program instructions to generate, using a first key, a first set of round keys for rounds of an AES algorithm; program instructions to generate, using a second key, a second set of round keys for the rounds of AES algorithm; program instructions to determine different addresses, of a plurality of memory devices, for the first set of round keys and for the second set of round keys, wherein first addresses of a first round key, of the first set of round keys, are determined based on: a round of AES algorithm associated with the first round key, the first key, and first indexes of words included in the first round of key, and wherein second addresses of a second round key, of the second set of round keys, are determined based on a round of AES algorithm associated with the second round key, the second key, and second indexes of words included in the second round of key; and program instructions to store the first set of round keys and the second set of round keys in the different addresses, wherein the first round key is stored in a memory device, of the plurality of memory devices, using a first port of the memory device, and wherein the memory device is a dual port memory device that includes the first port and a second port.

Example 17 includes the computer program product of Example 16, wherein the memory device includes a dual-port static random access memory.

Example 18 includes the computer program product of Example 16, wherein the memory device includes a dual-port register file.

Example 19 includes the computer program product of any of Examples 16-18, wherein the first set of round keys and the second set of round keys are generated as part of AES-GCM.

Example 20 includes the computer program product of Example 19, wherein round keys, of the first set of round keys and of the second set of round keys, that are generated for a round of AES algorithm are stored on a particular memory device of the plurality of memory devices, and wherein storing the round keys, generated for the round of AES algorithm, on the particular memory device enables one physical AES-GCM instance to be used for the round keys for the round of AES algorithm.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

The descriptions of the present provisional specification and appendices may include examples to help enable one of ordinary skill in the art to practice the disclosed examples. The use of the terms “by example,” and “for example,” means that the related description is explanatory, and though the scope of the disclosure is intended to encompass the examples and legal equivalents, the use of such terms is not intended to limit the scope of an example, or limit this disclosure to the specified components, features, functions, or the like.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

It will be readily understood that the components of the examples as generally described herein could be arranged and designed in a wide variety of different configurations. Thus, the following descriptions of various examples is not intended to limit the scope of the present disclosure, but are merely representative of various examples.

Furthermore, specific implementations described are examples and is to not be construed as the sole way to implement the present disclosure. Elements, circuits, and functions may be shown in block diagram form in order not to obscure the present disclosure in unnecessary detail. Conversely, specific implementations shown and described are examples and is to not be construed as the sole way to implement the present disclosure unless specified otherwise herein. Additionally, block definitions and partitioning of logic between various blocks is examples of a specific implementation. It will be readily apparent to one having skill in the relevant art(s), given the description herein, that the present disclosure may be practiced by numerous other solutions. For the most part, details concerning timing considerations and the like have been omitted where such details are unnecessary to obtain a complete understanding of the present disclosure and are within the abilities of persons of ordinary skill in the relevant art.

The various illustrative logical blocks, modules, and circuits described in connection with the examples disclosed herein may be implemented or performed with a general purpose processor, a Digital Signal Processor (DSP), an Integrated Circuit (IC), an ASIC, a FPGA or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that could be depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be rearranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any tangible, non-transient medium that can facilitate transfer of a computer program from one place to another.

Any reference to an element herein using a designation such as “first,” “second,” “other,” “additional” and so forth does not necessarily limit the quantity or order of those elements. Rather, these designations may be used herein as a convenient method of distinguishing between two or more elements or instances of an element. Thus, a reference to first and second elements does not mean that solely two elements may be employed there or that the first element is to precede the second element in some manner. In addition, unless stated otherwise, a set of elements may comprise one or more elements.

It is understood that the computer processing systems, computer-implemented methods, apparatus, and computer program products described herein employ computer hardware and software to solve problems that are highly technical in nature (e.g., utilizing reliability characterization data to dynamically manage complex memory systems), that are not abstract and cannot be performed as a set of mental acts by a human. For example, a human, or even a plurality of humans, cannot rapidly and efficiently manage utilization of memory cells of a flash memory device with a level of accuracy and efficiency as the various implementations described herein.

While the implementations have been described above in the general context of computer-executable instructions that can run on one or more computers, those skilled in the art will recognize that the implementations can be also implemented in combination with other program modules and as a combination of hardware and software. For purposes of brevity, description of like elements and processes employed in other implementations is omitted.

Generally, program modules include routines, programs, components, and data structures, without limitation, that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, all of which can be operatively coupled to one or more associated devices.

The illustrated implementations of the implementations herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Terms used in the present disclosure and especially in the appended claims (e.g., bodies of the appended claims) are generally intended as “open” terms (e.g., the term “including” is to be interpreted as “including, but not limited to,” the term “having” is to be interpreted as “having at least,” the term “includes” is to be interpreted as “includes, but is not limited to,” without limitation).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases is to not be construed to imply that the introduction of a claim recitation by the indefinite articles “a” or “an” limits any particular claim containing such introduced claim recitation to examples containing one such recitation alone, even when the same claim includes the introductory phrases “one or more” or “at least one” and indefinite articles such as “a” or “an” (e.g., “a” or “an” is to be interpreted to mean “at least one” or “one or more”); the same holds true for the use of definite articles used to introduce claim recitations.

In addition, even if a specific number of an introduced claim recitation is explicitly recited, those skilled in the art will recognize that such recitation is to be interpreted to mean at least the recited number (e.g., the bare recitation of “two recitations,” without other modifiers, means at least two recitations, or two or more recitations). Furthermore, in those instances where a convention analogous to “at least one of A, B, and C, without limitation.” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, is to be understood to contemplate the possibilities of including one of the terms, either of the terms, or both terms. For example, the phrase “A or B” is to be understood to include the possibilities of “A” or “B” or “A and B.” As used herein, “each” means some or a totality.

Any characterization in this description of something as “typical,” “conventional,” or the like does not necessarily mean that it is disclosed in the prior art or that the discussed aspects are appreciated in the prior art.

What is claimed is:

1. A method comprising:
generating, using a first encryption key, a first set of round keys for rounds of an advanced encryption standard (AES) algorithm;
generating, using a second encryption key, a second set of round keys for the rounds of AES algorithm;
determining different addresses, of a plurality of memory devices, for the first set of round keys and for the second set of round keys,
wherein first addresses of a first round key, of the first set of round keys, are determined based on: a round of AES algorithm associated with the first round key, the first encryption key, and first indexes of words included in the first round of key, and
wherein second addresses of a second round key, of the second set of round keys, are determined based on a round of AES algorithm associated with the second round key, the second encryption key, and second indexes of words included in the second round of key;
storing the first set of round keys and the second set of round keys in the different addresses,
wherein the first round key is stored in a memory device, of the plurality of memory devices, using a first port of the memory device, and
wherein the memory device is a dual port memory device that includes the first port and a second port; and
retrieving the first set of round keys and the second set of round keys from the different addresses,
wherein the first round key is retrieved from the first memory device using the second port of the memory device.

2. The method of claim 1, wherein the memory device includes a static random access memory.

3. The method of claim 1, wherein the memory device includes a register file.

4. The method of claim 1, wherein round keys, of the first set of round keys and of the second set of round keys, that are generated for a first round of AES algorithm are stored on a first memory device of the plurality of memory devices, and wherein round keys, of the first set of round keys and of the second set of round keys, that are generated for a second round of AES algorithm are stored on a second memory device of the plurality of memory devices.

5. The method of claim 1, wherein the first set of round keys and the second set of round keys are generated as part of AES-galois/counter mode (GCM).

6. The method of claim 5, wherein round keys, of the first set of round keys and of the second set of round keys, that are generated for a round of AES algorithm are stored on a particular memory device of the plurality of memory devices, and wherein storing the round keys, generated for the round of AES algorithm, on the particular memory device enables one AES-GCM instance to be used for the round keys for the round of AES algorithm.

7. The method of claim 1, further comprising determining an address of a word of the first round key based on a round of AES algorithm associated with the first round key, the first encryption key, and an index of the word included in the first round of key.

8. The method of claim 1, further comprising:
receiving a request to perform an AES algorithm on data using a word of the first round key;
determining a round for the AES algorithm, an encryption key for the round, and an index for the word;
obtaining from the memory device, via the second port, the word; and
performing the AES algorithm on the data to obtain encrypted data.

9. A system comprising:
one or more processing units adapted to:
generate, using a first encryption key, a first set of round keys for rounds of an advanced encryption standard (AES) algorithm;
generate, using a second encryption key, a second set of round keys for the rounds of AES algorithm;
determine different addresses, of a plurality of memory devices, for the first set of round keys and for the second set of round keys,
wherein first addresses of a first round key, of the first set of round keys, are determined based on: a round of AES algorithm associated with the first round key, the first encryption key, and first indexes of words included in the first round of key, and
wherein second addresses of a second round key, of the second set of round keys, are determined based on a round of AES algorithm associated with the second round key, the second encryption key, and second indexes of words included in the second round of key; and
store the first set of round keys and the second set of round keys in the different addresses,
wherein the first round key is stored in a memory device, of the plurality of memory devices, using a first port of the memory device, and
wherein the memory device is a dual port memory device that includes the first port and a second port.

10. The system of claim 9, wherein the one or more processing units are adapted to retrieve the first set of round keys and the second set of round keys from the different addresses, wherein the first round key is retrieved from the first memory device using the second port of the first memory device.

11. The system of claim 9, wherein the memory device includes a dual-port static random access memory.

12. The system of claim 9, wherein the memory device includes a dual-port register file.

13. The system of claim 9, wherein the first set of round keys and the second set of round keys are generated as part of AES-galois/counter mode (GCM).

14. The system of claim 13, wherein round keys, of the first set of round keys and of the second set of round keys, that are generated for a round of AES algorithm are stored on a particular memory device of the plurality of memory devices, and wherein storing the round keys, generated for the round of AES algorithm, on the particular memory device enables one physical AES-GCM instance to be used for the round keys for the round of AES algorithm.

15. The system of claim 9, wherein the one or more processing units are adapted to determine an address of word of the first round key based on a round of AES algorithm associated with the first round key, the first encryption key, and an index of the word included in the first round of key.

16. A computer program product comprising:
one or more computer readable storage media, and program instructions collectively stored on the one or more computer readable storage media, the program instructions comprising:
program instructions to generate, using a first encryption key, a first set of round keys for rounds of an advanced encryption standard (AES) algorithm;
program instructions to generate, using a second encryption key, a second set of round keys for the rounds of AES algorithm;
program instructions to determine different addresses, of a plurality of memory devices, for the first set of round keys and for the second set of round keys,
wherein first addresses of a first round key, of the first set of round keys, are determined based on: a round of AES algorithm associated with the first round key, the first encryption key, and first indexes of words included in the first round of key, and
wherein second addresses of a second round key, of the second set of round keys, are determined based on a round of AES algorithm associated with the second round key, the second encryption key, and second indexes of words included in the second round of key; and
program instructions to store the first set of round keys and the second set of round keys in the different addresses,
wherein the first round key is stored in a memory device, of the plurality of memory devices, using a first port of the memory device, and
wherein the memory device is a dual port memory device that includes the first port and a second port.

17. The computer program product of claim 16, wherein the memory device includes a dual-port static random access memory.

18. The computer program product of claim 16, wherein the memory device includes a dual-port register file.

19. The computer program product of claim 16, wherein the first set of round keys and the second set of round keys are generated as part of AES-galois/counter mode (GCM).

20. The computer program product of claim 19, wherein round keys, of the first set of round keys and of the second set of round keys, that are generated for a round of AES algorithm are stored on a particular memory device of the plurality of memory devices, and wherein storing the round keys, generated for the round of AES algorithm, on the particular memory device enables one physical AES-GCM instance to be used for the round keys for the round of AES algorithm.
